(19) United States
(12) Patent Application Publication
(10) Pub. No.: US 2011/0125478 A1
(43) Pub. Date: May 26, 2011

(54) METHODS AND SYSTEMS FOR DETERMINING LOCALIZED DIELECTRIC PROPERTIES OF A MOLECULE

(76) Inventors: William C. Guest, Vancouver (CA); Steven S. Plotkin, Vancouver BC (CA); Neil R. Cashman, Vancouver (CA)

(21) Appl. No.: 12/952,140

(22) Filed: Nov. 22, 2010

Related U.S. Application Data
(60) Provisional application No. 61/272,934, filed on Nov. 20, 2009.
(60) Provisional application No. 61/264,693, filed on Nov. 26, 2009.

(51) Int. Cl. G06G 7/48

(52) U.S. Cl. 703/12

(57) ABSTRACT

The present disclosure describes methods, systems and techniques for determining a localized dielectric property of a molecule. A molecular model of at least a portion of the molecule is obtained. The molecular model is partitioned into cavities, and for each of the cavities, the permittivity within the cavity is iteratively determined based on permittivity outside of the cavity and electronic and nuclear polarizability within the cavity. Beneficially, this allows for different permittivities to be determined for different portions of the molecule, and is advantageous over simply assigning a single permittivity to the entire molecule.

### CROSS REFERENCE TO RELATED APPLICATIONS

Pursuant to 35 U.S.C. §119(e), this application claims the benefit of provisional U.S. Patent Application No. 61/272,934, filed Nov. 20, 2009 and entitled “Methods and systems for determining localized dielectric properties of a protein,” and of provisional U.S. Patent Application No. 61/264,693, filed Nov. 26, 2009 and entitled “Methods and Systems for Determining Localized Dielectric Properties of a Molecule,” the entireties of which are hereby incorporated by reference herein.

### TECHNICAL FIELD

The present disclosure is directed at methods, systems and techniques for determining localized dielectric properties of a molecule. More specifically, the present disclosure is directed at methods, systems and techniques for determining localized relative permittivity at points in a molecule.

### BACKGROUND

The study of the dielectric properties of a dielectric media may provide useful information on the stability and function of the media.

A quantitatively accurate theory for the dielectric properties of polar liquids and solids took form only after several decades, starting with the early work of Lorentz (H. A. Lorentz, The theory of electrons and its applications to the phenomena of light and radiant heat, B. G. Teubner, Leipzig, 1916) and reaching predictive power with the theories of Kirkwood and Oster for fluids (John G. Kirkwood, J. Chem. Phys., 1939, 7(10), 911-919; Gerald Oster and John G. Kirkwood, J. Chem. Phys., 1943, 11, 175-178) and Mott and Littleton (N. F. Mott and M. J. Littleton, Trans. Faraday Soc., 1938, 34, 485-489) for solids. Debye's original formulation (Peter Debye, Phys. Z., 1935, 36, 103) followed Langevin's theory of paramagnetism and quantifies the earlier observations of Clausius and Mossotti for the relative permittivity ∈ of gases:

$$\frac{ε - 1}{ε + 2} = \frac{4 π}{3} {\sum }_{i} {n}_{i} ( {a}_{i} + \frac{{μ}_{i}^{2}}{3 {k}_{B} T} ) . \qquad ( 1 )$$

In Equation (1), the sum is over species of molecules, α and μᵢ are the electronic polarizability and permanent electric dipole moment of species i, nᵢ is the number per cm³ of species i, k_{B} is the Boltzmann constant, T is the absolute temperature, and k_{B}T is the thermal energy. This analysis yields a relative permittivity which increases as temperature is decreased due to the more effective alignment of dipoles against thermal randomization.

For a positive relative permittivity, the left hand side of Equation (1) is bounded by unity, while the right hand side is not. In fact, if known values for the electronic polarizability, molecular dipole moment, and density at room temperature for a substance such as water are substituted, Equation (1) can only be satisfied by a negative relative permittivity. This is a consequence of the assumption of the Lorentz field for the local field in the model, i.e. the model predicts ferro-electricity for a substance such as water below a temperature T_{c}=4πnμ²/9 k_{B}≈1900K analogous to Weiss ferromagnetism.

Onsager's treatment of the local field resulted in a reaction field which could polarize a molecule but not align it, and a cavity field which could provide torque on a dipolar molecule (L. Onsager, J. Am. Chem. Soc., 1936, 58, 1486-1493). This theory eliminated the need for negative relative permittivities, but still predicted relative permittivities about half of the experimental values for substances such as water.

Oster and Kirkwood's more explicit treatment of dipole-dipole correlations (John G. Kirkwood, J. Chem. Phys., 1939, 7(10), 911-919) predicted relative permittivities within a few percent for water by treating the alignment of a water molecule dipole with that of its neighbors (Gerald Oster and John G. Kirkwood, J. Chem. Phys., 1943, 11, 175-178). This treatment results in an increased relative permittivity when molecules align their neighbors in a ferromagnetic fashion, with Kirkwood's expression for the relative permittivity (for 1 species)

$$\frac{( ε - 1 ) ( 2 ε + 1 )}{ε} = 12 π n [ α + \frac{{μ}^{2}}{3 {k}_{B} T} ( 1 + n {\int }_{{v}_{0}} d v d Ωcosγ {e}^{- W / {k}_{B} T} ) ] \qquad ( 2 )$$

wherein, ∈ is the relative permittivity of the dielectric, α is the electronic polarizability of the dielectric, Ω is the integration over all possible angles of a dipole, dv is an integration over a sphere of volume vₒ, γ is the angle between two nearest-neighbor dipoles, n is the integration over all nearest neighbor dipoles, W is the energy function describing the barrier to dipole rotation, n is the number of nearest neighbor dipoles, k_{B} is Boltzmann's constant, μ is the molecular dipole moment, and T is the absolute temperature.

One application for the theory of polar dielectric media is the study of electrostatic effects in biomolecules, such as proteins, which influence their stability and function. An understanding of these effects requires an accurate description of protein dielectric properties, which determine the strength of interactions between charges in the protein. However, unlike a homogeneous liquid whose relative permittivity does not vary throughout its volume, the dielectric response of a biomolecule typically varies from site to site depending on the local molecular structure. Furthermore, complex constraint forces within the molecule may cause only partial alignment of local dipoles with an applied external field, introducing anisotropic effects.

The advent of automated Poisson-Boltzmann equation solvers like APBS (N. A. Baker, D. Sept, S. Joseph, M. J. Holst, J. A. McCammon, Proc. Natl. Acad. Sci., 2001, 98, 10037-10041) and DelPhi (W. Rocchia, S. Sridharan, A. Nicholls, E. Alexov, A. Chiabrera, and B. Honig, J. Comp. Chem., 2002, 23, 128-137) has enabled the rapid calculation of protein electrostatic energies. These tools commonly assume a constant internal dielectric environment for proteins which neglects local variation in susceptibility, however, measurements such as pKₐ shifts indicate a much richer profile for the effective relative permittivity in proteins (A. R. Fersht, M. J. Sternberg, Protein Eng., 1989, 2, 527-530; D. G. Isom et al. Proc Natl Acad Sci, 2010 107 16096-16100).

### BRIEF DESCRIPTION OF THE DRAWINGS

FIG. 1 is a schematic representation of an approach to determine the localized dielectric properties about a point in a protein according to one embodiment.

FIG. 2 is a flow diagram of a method of determining localized dielectric properties of a protein according to one embodiment.

FIG. 3 provides a correlation map for dipoles in ubiquitin, a graph of the correlation coefficient between dipole products in ubiquitin, and a graph of the first four moments of the distribution of dipole correlation values in ubiquitin.

FIG. 4 is a graph of the effect of sphere radius of a cavity on the determined relative permittivity taken on a line through the geometric centre of ubiquitin.

FIG. 5 is a system diagram of a system for determining localized dielectric properties of a protein according to one embodiment.

FIG. 6 is a diagram representing the anisotropic relative permittivity on a plane through the centre of ubiquitin. Each ellipse describes the dielectric tensor at a lattice point, with the length of the ellipse axes given by the reciprocal eigenvalues of the dielectric tensor (to emphasize the protein interior) and the orientation of the ellipse given by the eigenbasis of the tensor. The spacing between ellipses is 1 Angstrom in each direction.

FIG. 7 is a diagrammatic representation of the anisotropic dielectric constant. The orientation of each ellipsoid is given by the eigenbasis of the dielectric tensor at that point; the lengths of the semimajor axes are directly proportional to the eigenvalues of the tensor. Only ellipsoids with a difference between eigenvalues of >25% are shown.

FIG. 8 is a diagram of the iso-dielectric contours around the adenylate kinase (Protein Data Bank Reference Code 1AKY) structure.

FIG. 9 is graph of the effective scalar relative permittivity on a horizontal plane through the geometric centre of adenylate kinase (1AKY).

FIG. 10 is a comparison of salt bridge energies determined using a homogeneous protein relative permittivity and an inhomogeneous relative permittivity, the inhomogeneous relative permittivities being determined using a method of determining localized dielectric properties of a protein according to one embodiment.

FIG. 11 is a graph depicting an energy profile of sodium ion passage through the acetycholine receptor pore for five choices of homogeneous and inhomogeneous relative permittivities, the inhomogeneous relative permittivities being determined using a method of determining localized dielectric properties of a protein according to one embodiment.

FIG. 12 is a schematic depiction of the effect of dielectric anisotropy on electric field geometry.

FIG. 13 is a diagram of the effective scalar dielectric function in and around a hypothetical polyglutamine helix.

FIG. 14 is a schematic of a method of determining salt bridge and total electrostatic energies according to one embodiment.

FIG. 15 is an illustration of the 4 largest-amplitude dipole correlation modes in human prion protein as obtained from diagonalization of the dipole correlation matrix.

FIG. 16 shows conserved nonlocal salt bridges present in the bovine PrP molecule.

FIG. 17 shows the most attractive and repulsive salt bridges from a set of prion protein species.

FIG. 18 provides a histogram of salt bridge energies in prion proteins across species determined in one example, and a graph of the total salt bridge energies in prion protein in a number of molecular species found in one example.

FIG. 19 is a table of salt bridge energies determined for the human prion protein in one example using both homogeneous relative permittivities and inhomogeneous relative permittivities, the inhomogeneous relative permittivities being determined using a method of determining localized dielectric properties of a protein according to one embodiment.

FIG. 20 provides a table of residues in human PrP determined to have the greatest total electrostatic energy in one example as determined using inhomogeneous relative permittivities determined using a method of determining localized dielectric properties of a protein according to one embodiment.

FIG. 21 is a graph of hydrophobic transfer energy for strands of seven residues centred for four species of PrP^{c} found in one example.

### DETAILED DESCRIPTION

According to a first aspect, there is provided a method for determining a localized dielectric property of a molecule. The method includes obtaining a molecular model of at least a portion of the molecule; partitioning the molecular model into cavities; and iteratively determining, for each of the cavities, permittivity within the cavity based on permittivity outside of the cavity and electronic and nuclear polarizability within the cavity.

Obtaining the molecular model may include determining the structure of the portion of the molecule by performing a molecular dynamics simulation of the portion of the molecule; and selecting the molecular model that represents the structure of the portion of the molecule. The molecular dynamics simulation may include frames recording the portion of the molecule. Additionally, prior to iteratively determining permittivity, the method may also include identifying dipoles from the frames; determining the locations of the dipoles in the frames; and determining the electronic polarizability inside each of the cavities for which permittivity is to be determined from the locations of the dipoles, a fraction of the cavity occupied by a solvent in which the molecule is immersed, and freedom of the dipoles to reorient in response to an external field.

Additionally or alternatively, prior to iteratively determining permittivity, the method may also include determining the orientations of the dipoles in the frames; determining correlations of the deviations of the dipoles over the frames; and determining the nuclear polarizability inside the cavity from the locations, orientations, and deviations of the dipoles.

Iteratively determining permittivity may include determining a permittivity model of the permittivity inside the cavity based on the permittivity outside of the cavity and the electronic and nuclear polarizability within the cavity; and iteratively solving the permittivity model to determine the permittivity within any particular one of the cavities by repeating until convergence: determining the permittivity outside the cavity based on average permittivity within a selected volume outside the cavity; and determining the permittivity inside the cavity by solving the permittivity model associated with the cavity.

The molecule may be selected from the group of a protein, an inorganic molecule, an organic molecule, a lipid, and a nucleic acid.

The molecule may be a protein. Identifying the dipoles from the frames may include identifying one or both of the residue backbone and residue side chain of the portion of the protein represented in the frames. Selecting the molecular model may include selecting a predetermined atomic-resolution protein structure. Selecting the molecular model may include determining a protein structure wherein the position of each of the atoms in the protein structure minimizes average root-mean-square deviation of the atoms over one or more of the frames.

Partitioning the molecular model into cavities may include selecting a lattice of points separated by a fixed distance; and locating one of the cavities around each of the points. Each of the cavities may be a sphere centered on one of the points.

Iteratively determining permittivity may include determining:

∈₂=∈₁(2 [symbol] +I)(I− [symbol] )⁻¹,

wherein:

$$𝕎 ≡ I + \frac{3 {ε}_{1}}{2 {ε}_{1} + 1} ( \frac{( 1 + γℱ α ) ( γ ) + αγ}{{a}^{3}} - ( 1 + γℱ α ) ( I + γℱ ) )$$

$$γ = 1 / ( 1 - α ℱ )$$

$$ℱ = 2 ( {ε}_{1} - 1 ) / ( ( 2 {ε}_{1} + 1 ) {a}^{3} )$$

$$α ( r \vert a ) = {\sum }_{A = 1}^{N} {f}_{A} ( r \vert a ) {α}^{A} + {n}_{w} ( r \vert a ) {α}^{w}$$

$${ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T}$$

[symbol] ₂ is the tensorial permittivity inside the cavity;
∈₁ is the scalar permittivity outside the cavity;
I is the identity matrix;
a is the radius of the cavity;
α is the electronic polarizability in the cavity;
N is the total number of dipoles in the molecule;
ƒ_{A} is the average fraction of a dipole A in the cavity;
α^{A} is the electronic polarizability of a dipole A;
n_{w} is the number of solvent molecules in the cavity;
α^{A} is the electronic polarizability the solvent in the cavity;
[symbol] is the tensorial nuclear polarizability in the cavity;
[symbol] μᵢ^{A}μⱼ^{B} [symbol] is the correlation of the dipoles in the cavity over all frames;
k_{B} is the Boltzmann constant;
T is the temperature in degrees Kelvin;
ƒ_{B} is the average fraction of a dipole B in the cavity;
g is the Kirkwood factor giving the average sum of the dot products of a solvent molecule's dipole moment with those of its nearest neighbors;
p is the permanent dipole moment of the solvent molecules; and
δᵢⱼ is the Kronecker delta function defined to be 1 if i=j and 0 otherwise.

Determining the average permittivity within a selected volume outside the cavity may include averaging the permittivity over points contained in the selected volume.

They method may also include using the permittivity determined in any one or more of the cavities for any one or more of the following: to model protein unfolding; to calculate equilibrium acid/base dissociation constants for ionizable groups in a protein; to predict protein-protein interactions; to calculate ligand docking energies for computer-aided drug design; to calculate interaction energies between charged groups within a protein, and their enthalpy of transfer into different solvent conditions; and as an implicit solvation model in molecular dynamics.

The tensorial permittivity inside the cavity may be reduced to a scalar quantity by averaging eigenvalues of the tensorial permittivity. The eigenvalues may be averaged by determining any one or more of geometric, harmonic, and arithmetic means.

According to another aspect, there is provided a system for determining a localized dielectric property of a molecule. The system includes an input unit configured to obtain a molecular model of at least a portion of the molecule; a partitioning unit configured to partition the molecular model into cavities; and a permittivity computation unit configured to iteratively determine, for each of the cavities, permittivity within the cavity based on permittivity outside of the cavity and electronic and nuclear polarizability within the cavity.

The molecular model may be obtained according to a method comprising: determining the structure of a portion of the molecule by performing a molecular dynamics simulation of the portion of the molecule; and selecting the molecular model that represents the structure of the portion of the molecule.

The molecular dynamics simulation may include frames recording the portion of the molecule. The system may also include a dipole identification unit configured to identify dipoles from the frames and to determine the locations of the dipoles in the frames, and the permittivity computation unit may be further configured to determine the electronic polarizability inside each of the cavities for which permittivity is to be determined from the locations of the dipoles, a fraction of the cavity occupied by a solvent in which the molecule is immersed, and freedom of the dipoles to reorient in response to an external field.

The dipole identification unit may be further configured to determine the orientations of the dipoles in the frames and the correlations of the deviations of the dipoles over the frames, and the permittivity computation unit may be further configured to determine the nuclear polarizability inside the cavity from the locations, orientation, and deviations of the dipoles.

The permittivity computation unit may be configured to determine a permittivity model of the permittivity inside the cavity based on the permittivity outside of the cavity and the electronic and nuclear polarizability within the cavity; and iteratively solve the permittivity model to determine the permittivity within any particular one of the cavities by repeating until convergence: determining the permittivity outside the cavity based on average permittivity within a selected volume outside the cavity; and determining the permittivity inside the cavity by solving the permittivity model associated with the cavity.

The molecule may be a protein, an inorganic molecule, an organic molecule, a lipid, and a nucleic acid.

When the molecule is a protein, identifying the dipoles from the frames may include identifying one or both of the residue backbone and residue side chain of the portion of the protein represented in the frames. Selecting the molecular model may include selecting a predetermined atomic-resolution protein structure. Selecting the molecular model may also include determining a protein structure wherein the position of each of the atoms in the protein structure minimizes average root-mean-square deviation of the atoms over one or more of the frames.

The partitioning unit may be configured to partition the molecular model into cavities according to a method including selecting a lattice of points separated by a fixed distance; and locating one of the cavities around each of the points. Each of the cavities is a sphere centered on one of the points.

The permittivity computation unit may be configured to determine permittivity within any particular one of the cavities by determining:

[symbol]

₂=∈₁(1 [symbol] +I)(I− [symbol] )⁻¹,

wherein:

$$𝕎 ≡ I + \frac{3 {ε}_{1}}{2 {ε}_{1} + 1} ( \frac{( 1 + γℱ α ) ( γ ) + αγ}{{a}^{3}} - ( 1 + γℱ α ) ( I + γℱ ) )$$

$$γ = 1 / ( 1 - α ℱ )$$

$$ℱ = 2 ( {ε}_{1} - 1 ) / ( ( 2 {ε}_{1} + 1 ) {a}^{3} )$$

$$α ( r \vert a ) = {\sum }_{A = 1}^{N} {f}_{A} ( r \vert a ) {α}^{A} + {n}_{w} ( r \vert a ) {α}^{w}$$

$${ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T}$$

[symbol] ₂ is the tensorial permittivity inside the cavity;
∈₁ is the scalar permittivity outside the cavity;
I is the identity matrix;
a is the radius of the cavity;
α is the electronic polarizability in the cavity;
N is the total number of dipoles in the molecule;
ƒ_{A} is the average fraction of a dipole A in the cavity;
α^{A} is the electronic polarizability of a dipole A;
n_{w} is the number of solvent molecules in the cavity;
α^{A} is the electronic polarizability the solvent in the cavity;
[symbol] is the tensorial nuclear polarizability in the cavity;
[symbol] μᵢ^{A}μⱼ^{B} [symbol] is the correlation of the dipoles in the cavity over all frames;
k_{B} is the Boltzmann constant;
T is the temperature in degrees Kelvin;
ƒ_{B} is the average fraction of a dipole B in the cavity;
g is the Kirkwood factor giving the average sum of the dot products of a solvent molecule's dipole moment with those of its nearest neighbors;
p is the permanent dipole moment of the solvent molecules; and
δᵢⱼ is the Kronecker delta function defined to be 1 if i=j and 0 otherwise.

The permittivity computation unit may be configured to determine the average permittivity within a selected volume outside the cavity according to a method comprising averaging the permittivity over points contained in the selected volume.

The system may also include an application unit configured to use the permittivity determined in any one or more the cavities to model protein unfolding.

The application unit may be configured to use the permittivity determined in any one or more the cavities to perform any one or more of the following: to calculate equilibrium acid/base dissociation constants for ionizable groups in a protein; to use the permittivity determined in any one or more the cavities to predict protein-protein interactions; to calculate ligand docking energies for computer-aided drug design; to calculate interaction energies between charged groups within a protein, and their enthalpy of transfer into different solvent conditions; and as an implicit solvation model in molecular dynamics.

The permittivity computation unit may be further configured to reduce the tensorial permittivity inside the cavity to a scalar quantity by averaging eigenvalues of the tensorial permittivity. The eigenvalues may be averaged by determining any one or more of geometric, harmonic, and arithmetic means.

According to another aspect, there is provided a method of operating a system to determine localized dielectric properties of at least a portion of a molecule, the system comprising an input unit, a dipole identification unit, a partitioning unit, and a permittivity computation unit, the method comprising:
(a) obtaining by the input unit a plurality of frames from a molecular dynamics simulation of the portion of the molecule;
(b) selecting by the dipole identification unit a plurality of dipoles from the frames;
(c) determining by the dipole identification unit the location and orientation of each dipole in each frame;
(d) determining by the dipole identification unit the correlations of the deviations of the dipoles from their time-averaged positions and orientations over the frames;
(e) selecting by the partitioning unit a molecular model representing the structure of the portion of the molecule;
(f) selecting from the molecular model by the partitioning unit one or more points;
(g) for each point:
   (i) selecting from the molecular model by the partitioning unit a cavity around the point; and
   (ii) determining by the permittivity computation unit a permittivity model of the permittivity inside the cavity based on the permittivity outside the cavity, the electronic polarizability inside the cavity, and the nuclear polarizability inside the cavity;
(h) determining by the permittivity computation unit the permittivity inside each cavity by solving the permittivity models.

Determining by the permittivity computation unit the permittivity inside each cavity by solving the permittivity models may comprise:
(a) for each cavity, selecting an initial permittivity inside the cavity and an initial permittivity outside the cavity;
(b) repeating the following until the permittivities determined for the inside the cavities converge to at least a minimum degree;
   (i) for each cavity:
      (1) determining the permittivity outside the cavity based on the average permittivity within a selected volume outside the cavity; and
      (2) determining the permittivity inside the cavity by solving the permittivity model associated with the cavity.

The molecule may be a multi-molecule system. The molecule may also be an inorganic molecule, or organic molecule, such as a protein, lipid, or nucleic acid.

Selecting by the dipole identification unit a plurality of dipoles from the frames may comprise selecting the residue backbone and residue side chain of each residue of the portion of the protein represented in each frame.

Selecting by the partitioning unit a molecular model representing the structure of a portion of protein may comprise selecting a predetermined atomic-resolution protein structure.

Selecting by the partitioning unit a molecular model representing the structure of a portion of protein may comprise determining a protein structure wherein the position of each atom in the protein structure minimizes the average root-mean-square deviation of the atoms from their average positions over all of the frames.

Selecting from the molecular model by the partitioning unit one or more points may comprise selecting a lattice of points separated by a fixed distance.

Selecting from the molecular model by the partitioning unit a cavity around the point may comprise selecting a sphere centred on the point.

Determining by the permittivity computation unit a permittivity model of the permittivity inside the cavity based on the permittivity outside the cavity, the electric polarizability inside the cavity, and the nuclear polarizability inside the cavity may comprise:

$${2}_{} = {c}_{1} ( 2 𝕎 + I ) {( I - 𝕎 )}^{- 1}$$

$$𝕎 ≡ I + \frac{3 {ε}_{1}}{2 {ε}_{1} + 1} ( \frac{( 1 + γℱ α ) ( γ ) + αγ}{{a}^{3}} - ( 1 + γℱ α ) ( I + γℱ ) )$$

$$γ = 1 / ( 1 - α ℱ )$$

$$ℱ = 2 ( {ε}_{1} - 1 ) / ( ( 2 {ε}_{1} + 1 ) {a}^{3} )$$

$$α ( r \vert a ) = {\sum }_{A = 1}^{N} {f}_{A} ( r \vert a ) {α}^{A} + {n}_{w} ( r \vert a ) {α}^{w}$$

$${ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T}$$

wherein,
[symbol] ₂ is the tensorial permittivity inside the cavity;
∈₁ is the scalar permittivity outside the cavity;
I is the identity matrix;
a is the radius of the cavity;
α is the electronic polarizability in the cavity;
N is the total number of dipoles in the molecular system;
ƒ_{A} is the average fraction of a dipole A in the cavity;
α^{A} is the electronic polarizability of a dipole A;
n_{w} is the number of solvent molecules in the cavity;
α^{A} is the electronic polarizability the solvent in the cavity;
[symbol] is the nuclear polarizability in the cavity;
[symbol] μᵢ^{A}μⱼ^{B} [symbol] is the correlation of the dipoles in the cavity over all frames;
k_{B} is the Boltzmann constant;
T is the temperature in degrees Kelvin;
ƒ_{B} is the average fraction of a dipole B in the cavity;
g is the Kirkwood factor giving the average sum of the dot products of a solvent molecule's dipole moment with those of its nearest neighbors;
p is the permanent dipole moment of the solvent molecules; and
δᵢⱼ is the Kronecker delta function defined to be 1 if i=j and 0 otherwise.

Determining the permittivity outside the cavity based on the average permittivity within a selected volume outside the cavity may comprise averaging the permittivities at points contained in the selected volume.

According to another aspect, there is provided a computer readable medium having encoded thereon statements and/or instructions to cause a processor to execute any of the foregoing methods.

In some of the exemplary embodiments described below, methods and systems of determining the localized dielectric properties of a molecule are described as being applied to proteins. However, it is to be understood that the application of the methods and systems described herein are not limited to proteins, and may be applied to any suitable molecule or system of molecules.

Method for Determining Localized Dielectric Properties of a Molecule

In one embodiment, there is provided a method for determining localized dielectric properties of a protein. The dielectric properties of a protein can be determined by characterizing its response to applied electric fields. The protein can be modelled as an assembly of fluctuating dipoles at locations determined by the native protein fold. Unlike liquids, where dipoles are relatively free to orient with the prevailing applied electric field (subject to local organization of the liquid), stereochemical intramolecular forces typically constrain the motion of the dipoles in the protein, so they may only partially align with an applied field. Furthermore, dipoles in the protein typically do not move independently, as the coupling of fluctuations due to the above-mentioned steric constraints in the protein may cause the dipoles to react in a coordinated fashion.

In principle, any two atoms participating in a covalent bond in the protein may be viewed as a dipole, however, the motions of atoms within the backbone and side chains of residues in a protein are typically highly correlated by the covalent bond network. Thus, in the present embodiment, the effective dipoles are defined as groups of atoms in each residue backbone or residue side chain. In the alternative, for glycine, alanine, and proline, all the atoms in each one of these residues may be considered as a single dipole since their side chains are structurally incapable of motion substantially independent of their backbones. In the further alternative, the effective dipoles may be defined as other suitable groupings of atoms in the protein.

In the absence of an applied electric field, the dipoles in the protein undergo thermal fluctuations that are not necessarily isotropic, namely, there may be greater average motion in some directions compared to others. For example, fluctuations perpendicular to the time-average dipole orientation may be greater than those parallel the average dipole. Thus, each dipole may have its own system of principal axes characterizing its response an external field.

In the present embodiment, the protein is considered as being comprised of n dipoles, each with dipole moment components in the x, y, and z directions. A vector μ of length 3n is constructed that contains the deviations of all the protein dipole moment components from their equilibrium values, such that the x, y, and z components of the i^{th} dipole's deviations are μ₃ᵢ₋₂, μ₃ᵢ₋₁, μ₃ᵢ, respectively. Thus, <μ>₀=0, where the angle brackets refer to the thermal average in zero external field.

In the presence of a local electric field E=(Eₓ, E_{y}, E_{z}), which can vary dipole to dipole, the change in free energy by perturbing the configuration of dipoles from their equilibrium positions is (to 2nd order in μ):

$$Δ G = \frac{1}{2} {\sum }_{i , j = 1}^{3 n} {K}_{ij} {μ}_{i} {μ}_{j} - {\sum }_{i = 1}^{3 n} {E}_{i} {μ}_{i} \qquad ( 3 )$$

wherein, Eᵢ are the components of the vector E=(E₁, E₂, . . . Eₙ) representing the local field on all n dipoles, and Kᵢⱼ is the second derivative matrix elements ∂²G/∂μᵢ∂μᵢ|₀ evaluated at the equilibrium position μ=0.

The probability for a protein to occupy a given configuration at equilibrium is proportional to exp(ΔG/k_{B}T). Thus, the averages of the induced dipole moment and cumulant matrix elements can be found by diagonalizing the free energy and are given by:

$$\begin{matrix}{〈 {μ}_{i} {μ}_{j} 〉}_{c} = {k}_{B} {T ( {K}^{- 1} )}_{ij} & ( 4 a ) \\ 〈 {μ}_{i} 〉 = {\sum }_{j} {( {K}^{- 1} )}_{ij} {E}_{j} = \frac{1}{{k}_{B} T} {\sum }_{j} {〈 {μ}_{i} {μ}_{j} 〉}_{c} {E}_{j} & ( 4 b )\end{matrix}$$

Equations (4a) and (4b) define the cumulant matrix elements which represent the average product of all pairs of dipole components over a simulation. Since the average of μ is 0 in the absence of an external field, the cumulant matrix elements may be replaced by the unperturbed averages < . . . >₀.

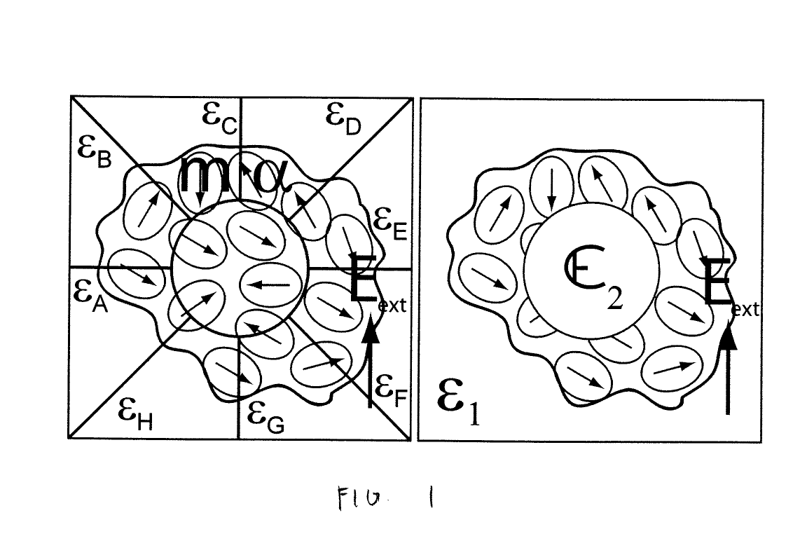

The effective local relative permittivity at a point in a protein is determined by considering the equivalence between microscopic and macroscopic descriptions of the electric response of nearby media, as depicted schematically in FIG. 1. In the microscopic description, the matter within a cavity of radius a around this point is considered to have a dipole moment m and polarizability α, placed in a cavity of the same radius within a dielectric with permittivity δ₁ that accounts for the response of the solvent and/or protein surrounding the cavity. In the macroscopic description, this cavity is considered to be filled with a dielectric medium of permittivity [symbol] ₂, surrounded by the dielectric ∈₁. A permittivity model of the permittivity inside the cavity, [symbol] ₂, is determined based on the permittivity outside the cavity, ∈₁, the electronic polarizability inside the cavity, α, and the nuclear polarizability inside the cavity, [symbol] .

The space in and around the protein is partitioned into a lattice of points with spacing b. For each point in the lattice at a location r, a cavity centered at r and having radius α is selected. Each cavity may contain parts of several dipoles and has an internal local field E(r|α). The dipoles in each cavity are assumed to experience the same total field. In each cavity, the contribution of each dipole to the induced cavity dipole moment is taken to depend on the volume fraction of the dipole within the cavity. Let ƒ_{A}(r|a) be the volume fraction of residue A inside the cavity centered at position r, given the cavity has radius α. To obtain the static dielectric response, ƒ_{A}(r|a) is determined as the time-averaged fraction of A in the cavity. The i^{th} component of the field-induced moment inside each cavity is given by a sum over both the residues and x, y and z components of each residue's dipole moment. The sums may be written separately, rewriting Equation (4b) as [symbol] μᵢ^{A} [symbol] =(k_{B}T)⁻¹Σ_{B=1}ⁿρⱼ₌₁³ [symbol] μᵢ^{A}μⱼ^{B} [symbol] Eⱼ^{B}. The induced moment of the protein dipoles in the cavity, mₚ(r|a), is given by the sum of the induced moments of all residues weighted by the fraction of those residues inside the cavity:

$${m}_{p} ( r \vert a ) = {\sum }_{A = 1}^{N} 〈 {m}^{A} ( r \vert a ) 〉 = {\sum }_{A = 1}^{n} {f}_{A} ( r \vert a ) 〈 {μ}^{A} 〉 \qquad ( 6 )$$

In some cases, the cavity may be near the surface of the protein, where it will contain some number of solvent molecules, such as, for example, water. In such cases, the sum on residues in the cavity includes a contribution due to the solvent molecules inside it. The number of solvent molecules n_{w}(r|α) in a cavity is determined by taking the available volume in the cavity that is not occupied by the protein and dividing by the average volume of a solvent molecule at standard temperature and pressure (STP).

The electronic polarizability of the media depends on the proportions of residue backbones, residue side chains, and solvent in the cavity. Analogous to the permanent dipole response, the total electronic polarizability in the cavity is weighted by volume fractions:

$$α ( r \vert a ) = {\sum }_{A = 1}^{N} {f}_{A} ( r \vert a ) {α}^{A} + {n}_{w} ( r \vert a ) {α}^{w} . \qquad ( 7 )$$

The electronic polarizability α for each residue is taken as a scalar from the literature. In the alternative, the electronic polarizability α for each residue may be determined using other suitable methods. The contribution of water or other solvent to the cavity's dipole moment is determined based upon Kirkwood's analysis, in which the induced moment due to permanent dipole reorientation is given by:

$${m}_{w} ( r \vert a ) = {n}_{w} ( r \vert a ) \frac{{gp}^{2}}{3 kT} {E}_{e} . \qquad ( 8 )$$

wherein, p is the permanent dipole moment of solvent, Eₑ is the local effective field orienting the molecules, and g arises from the Kirkwood-Oster nearest-neighbor approximation of the term in parentheses on the right-hand side of Equation (2). For water, g has been previously calculated and found to be 2.67.

An analogous equation to Equation (8) may be derived with the refinement that the local electric field is reinterpreted as a field proportional to the cavity field, the cavity field being defined as the electric field within a volume of free space completely surrounded by a dielectric material formed by the application of an external field to the dielectric. In a cavity containing protein and solvent, the local field Eₑ experienced by the solvent and protein dipoles within the cavity may be considered to comprise a cavity field G, due to the externally applied perturbing field Eₑₓₜ, and a reaction field R, due to the response of the medium outside the cavity to the induced dipole within the cavity:

$$\begin{matrix}{E}_{e} = G + R \\ = \frac{3 {ε}_{1}}{2 {ε}_{1} + 1} {E}_{ext} + ℱ ( α {E}_{e} + m )\end{matrix} \qquad ( 9 )$$

wherein, F=2(∈₁−1)/((2∈₁+1)α³), α is the total electronic polarizability of the cavity from Equation (7), and m=mₚ+m_{w} is the total dipole moment due to the positions of atomic nuclei inside the cavity. Solving for Eₑ:

$${E}_{e} = \frac{1}{1 - α F} ( G + ℱ m ) ≡ γ ( G + ℱ m ) . \qquad ( 10 )$$

wherein, γ=1/(1−αF).

The total potential energy of the protein dipole component in the cavity is therefore a sum of the electric potential energy −mₚ·Eₑ and the steric potential energy) Iₛ(μₚ)=½Kᵢⱼ^{AB}μᵢ^{A}μⱼ^{B}, wherein the implied sums on A and B run from 1 to N and the sums on i and j run from 1 to 3. The steric potential constants Kᵢᵢ^{AB} from simulation implicitly include the protein dipole self-interaction term γ [symbol] ƒ_{A}ƒ_{B}μᵢ^{A}μᵢ^{B′} due to the effect of the protein dipole reaction field on the moment mₚ itself. Using Equations (3), (6), and (10):

$$U ( {m}_{p} ) = \frac{1}{2} {K}_{ij}^{AB} {μ}_{i}^{A} {μ}_{j}^{B} - γ ℱ {f}_{A} {μ}_{i}^{A} {m}_{i}^{w} - γ {f}_{A} {μ}_{i}^{A} {G}_{i} . \qquad ( 11 )$$

wherein the cavity field is applied only to dipoles in the cavity, resulting in the prefactor ƒ_{A} in the third term of Equation (11).

The total steric potential energy is also included to account for the statistics of dipoles inside the cavity. Thus, Equation (11) can be thought of as a hybrid potential energy. The potential energy of the solvent, on the other hand, is determined by the total effective field, as there are no internal steric constraints on its motion (except as embodied in the Kirkwood g-factor in Equation (8)). The solvent dipole self-interaction term γ [symbol] mᵢ^{w}mᵢ^{w} is zero in the case of isotropic polarizability α since the reaction field produced by the solvent dipole is parallel the dipole itself and therefore cannot apply a torque to it. In the present embodiment, the effects of the distensibility in magnitude of the nuclear part of the solvent dipole moment are neglected. In the alternative, the nuclear polarizability may be constructed as a tensor. In this case, the solvent dipole self-interaction term is non-zero. The solvent dipole potential energy is given by:

U(mₘ)=−(γ [symbol] ƒ_{A}μᵢ^{A}mᵢ^{w}−γmᵢ^{w}Gᵢ). (12)

Thus, the potential energy of solvent and protein dipoles is a sum of terms bilinear in the solvent and protein dipoles and linear in the effective cavity field γG. This has the form of the problem solved above in Equation (4b), so i^{th} component of the induced solvent and protein moments in the cavity are:

$$\begin{matrix}〈 {m}_{i}^{A} 〉 = {( {k}_{B} T )}^{- 1} {\sum }_{j = 1}^{3} ( {\sum }_{B = 1}^{N} {〈 {m}_{i}^{A} {m}_{j}^{B} 〉}_{0} + {〈 {m}_{i}^{A} {m}_{j}^{w} 〉}_{0} ) γ {G}_{j} & ( 13 a ) \\ 〈 {m}_{i}^{w} 〉 = {( {k}_{B} T )}^{- 1} {\sum }_{j = 1}^{3} ( {\sum }_{B = 1}^{N} {〈 {m}_{i}^{w} {m}_{j}^{B} 〉}_{0} + {〈 {m}_{i}^{w} {m}_{j}^{w} 〉}_{0} ) γ {G}_{j} , & ( 13 b )\end{matrix}$$

wherein the time average < . . . >₀ is taken in the absence of an external perturbing field.

The dipole polarizability to the cavity field is a property of correlations within the protein-solvent system itself. In this case, mutual reaction fields are the predominant influence the motion of the dipoles. The correlation functions involving solvent in Equations (13a) and (13b) can be evaluated by direct integration. The integration for protein dipoles is over all space, while it is confined to a sphere of radius p for the solvent dipoles. The potential energies in Equations (11) and (12) appear in a Boltzmann factor with the cavity field G=0; those Boltzmann factors not containing Kᵢⱼ are small compared to k_{B}T and may be linearized to give:

$$\begin{matrix}〈 {m}_{i}^{A} 〉 = {\sum }_{B = 1}^{N} {\sum }_{j = 1}^{3} ( {f}_{A} + ℱ {f}_{A} {f}_{B} \frac{{n}_{w} {gp}^{2}}{3 {k}_{B} T} ) \frac{{〈 {μ}_{i}^{A} {u}_{j}^{B} 〉}_{0}}{{k}_{B} T} γ {G}_{j} & ( 14 a ) \\ 〈 {m}_{i}^{w} 〉 = {\sum }_{j = 1}^{3} ( \frac{{n}_{w} {gp}^{2}}{3 {k}_{B} T} ) ( {δ}_{ij} + {\sum }_{A , B = 1}^{N} ℱ {f}_{A} {f}_{B} \frac{{〈 {μ}_{i}^{( A )} {u}_{j}^{( B )} 〉}_{0}}{{k}_{B} T} ) γ {G}_{j} & ( 14 b )\end{matrix}$$

Equations (14a) and (14b) can be combined and written generally as a matrix equation, with a nuclear polarizability tensor [symbol] relating the effective field γG and induced moment m=mₚ+m_{w}:

$$m ( r \vert a ) = ( r \vert a ) \cdot γ ( r \vert a ) G ( r \vert a ) , \\ with \\ {ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T} \qquad ( 15 )$$

The quantities [symbol] μᵢ^{A}μⱼ^{B} [symbol] may be obtained directly from molecular dynamics simulations of the protein in the absence of an external field, as described below.

With the response of permanent dipoles and polarizable media in a cavity established, the dielectric permittivity tensor at a location r may be determined. In a microscopic description, a set of polarizable constituents with induced and permanent dipole moments exist in a cavity of an isotropic, homogeneous dielectric medium with relative permittivity δ₁.

The total field Eᵢₙ inside the cavity at a position r may be considered as the superposition of the cavity field, the reaction field, and the dipole fields from the solvent and protein, such that:

$${E}_{in} = G + ℱ ( α {E}_{e} + 〈 m 〉 ) - ∇ ( \frac{α {E}_{e} \cdot r}{{r}^{3}} + \frac{〈 m 〉 \cdot r}{{r}^{3}} ) . \qquad ( 16 )$$

Substituting for <m> from Equation (15) and Eₑ from Equation (10), the potential inside the cavity is:

$${Φ}_{in} = ( 1 + γℱα ) ( I + γ ℱ ) G \cdot r + [ ( 1 + γ ℱα ) γ + αγ ] \frac{G \cdot r}{{r}^{3}} . \qquad ( 17 )$$

The potential outside the cavity may be considered as the superposition of the potentials from the external field (taken to be uniform), the field due the cavity in the dielectric, and the field due to the dipole in the cavity:

$${Φ}_{out} = - {E}_{ext} \cdot r + {a}^{3} \frac{r}{{r}^{3}} \cdot 𝕎 {E}_{ext} , \qquad ( 18 )$$

wherein [symbol] is defined by:

$$𝕎 ≡ I + \frac{3 {ɛ}_{1}}{2 {ɛ}_{1} + 1} ( \frac{( 1 + γ ℱα ) ( γ ) + αγ}{{a}^{3}} - ( 1 + γ ℱα ) ( I + γ ℱ ) ) . \qquad ( 19 )$$

Shifting to the equivalent macroscopic description of the system as a dielectric with permittivity tensor [symbol] ₂ surrounded by a dielectric with scalar permittivity δ₁, the potential in the surrounding dielectric is found to be:

$${Φ}_{out} = {E}_{ext} \cdot r + {{a}^{3} ( 2 I + {ɛ}_{1}^{- 1} {2}_{} )}^{- 1} ( {ɛ}_{1}^{- 1} {2}_{} - 1 ) E \cdot \frac{r}{{r}^{3}} . \qquad ( 20 )$$

Equating the microscopic and macroscopic expressions for the potential outside the cavity and solving for [symbol] ₂:

∈₂=∈₁(2 [symbol] +I)(I− [symbol] )⁻¹. (21)

This method of determining localized dielectric properties of a protein may be considered to fit in the middle of the microscopic-to-macroscopic continuum of techniques to describe biomolecule electrostatic properties. It is not fully microscopic in that individual atoms are collected into backbone and side chain dipoles to improve computational efficiency, and the applied fields are assumed to be approximately uniform within a selected cavity; conversely, by allowing the dielectric characteristics of a protein to vary throughout its volume it captures subtleties in electric effects that a purely macroscopic model may not capture. The method provides a robust and versatile tool for capturing much of the microscopic electrostatic behavior in a simple parameter like a locally-varying relative permittivity, which may then be refined by molecular dynamics simulation or density functional methods to explore interesting or noteworthy effects identified by the mesoscale method.

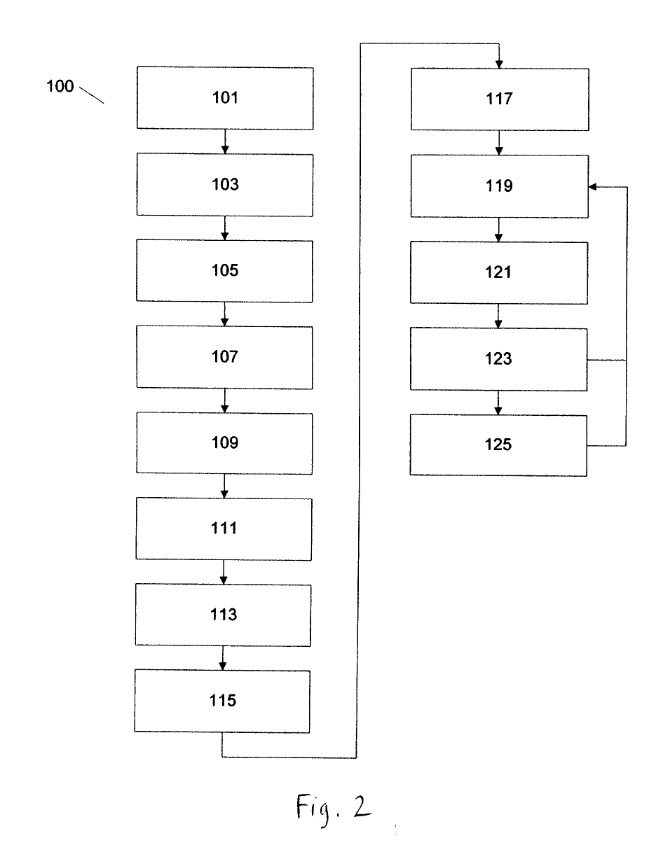

Referring to FIG. 2, in one embodiment, a method 100 for determining localized dielectric properties at point in a protein is shown comprising blocks 101 to 125. While the method 100 is described as applying to determining the localized dielectric properties of a protein, it is to be understood that the application of method 100 is not limited to proteins, and may be applied to any suitable molecule or system of molecules.

In block 101, a plurality of frames from an atomic-resolution molecular dynamics simulation of a protein are obtained. Each frame captures the state of the protein at a particular point in time during the simulation and provides information pertaining to each atom in the frame, such as, for example, atom type, atom coordinates, atomic mass, atomic charge, atomic radius, and atom relationship to other atoms. The molecular dynamics simulation is conducted using an atomic-resolution model of the protein obtained by methods, such as, for example, nuclear magnetic resonance, X-ray crystallography, electron microscopy or other methods known in the art. The atomic resolution structure of the protein may be directly available or may be determined based on the atomic resolution structure of another protein(s) or polypeptide(s) with amino acid sequence similarities to the protein of interest.

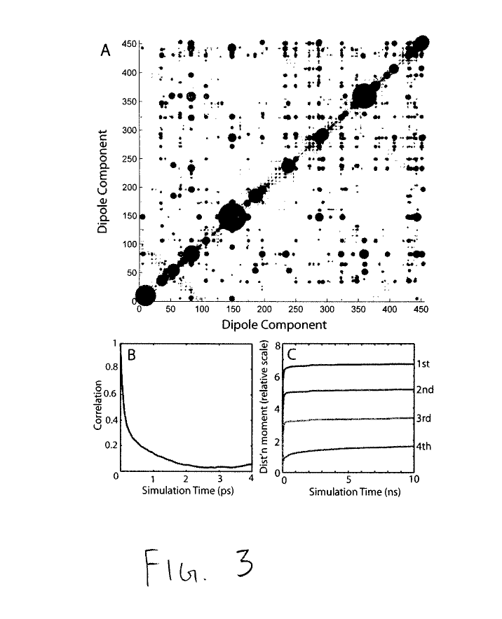

In the present embodiment, the molecular dynamics simulation is an all-atom classical molecular dynamics simulation of the protein at a temperature of 298K with periodic boundary conditions and explicit solvent using the CHARMM27 parameterized force field (N. Foloppe, J. Alexander, and D. MacKerell, J. Comput. Chem. 21, 86 2000.). The simulation time step is 2 fs and frames are captured every 1 ps. Information on each frame is presented in a Protein Data Bank (PDB) file in the PDB format. Alternatively, the simulation may be conducted with any desired simulation parameters (e.g. AMBER or TINKER force field parameterizations), frames may be captured at any desired frequency, and/or information on each frame may be presented in alternative file formats known in the art. In one example, shown in FIG. 3, the total simulation time required for convergence of the cumulants defined in Equations (4a) and (4b) to reliable values was approximately fns where the simulations were run for 2 ns. However, it will be understood that the minimum simulation time required for convergence of the cumulants may vary depending on the simulation parameters and protein-solvent system under simulation. Further, the total simulation time may be varied as desired.

In block 103, the dipoles in each frame are identified as the residue backbones and residue side chains in the frame. In the alternative, for glycine, alanine, and proline, all the atoms in each one of these residues may considered as a single dipole since their side chains are structurally incapable of motion substantially independent of their backbones. In the further alternative, the dipoles may be defined as other suitable groupings of atoms in the protein.

In block 105, the location and orientation of each identified dipole is determined. The location of each dipole is identified as the location of the centre of mass of the dipole determined using the location and molecular weight of each atom in the dipole. In the alternative, the location of the dipole and the origin for each dipole moment may be identified as the geometric center of the dipole or the center of any atom within the dipole. In the further alternative, the location of each dipole may be identified using other suitable methods. The orientation of each dipole is identified by determining the dipole moment vector of each dipole. In the alternative, the orientation of the each dipole may be determined using other suitable methods.

In block 107, the deviations of the dipoles amongst all of the frames is determined and correlated.

In block 109, a molecular model representing the protein is selected. The protein structure of the protein used in the molecular model is selected as a “best fit” protein structure determined by identifying the position of each atom in the protein that minimizes average root-mean-square deviation of the atoms over all of the frames. In the alternative, the protein structure of the protein used in the molecular model may be selected as a predetermined atomic-resolution protein structure obtained using the techniques described in block 101. In the further alternative, for proteins without a known atomic-detail structure, a molecular model may be determined by threading of the primary sequence to a homologous protein of known structure or from ab initio molecular simulations of protein folding. In the present exemplary embodiment, the sequence of the protein of known structure shares at least 50% sequence identity with the protein sequence to be threaded on to the known structure, and in alternative embodiments shares 90% or greater sequence identity.

The molecular model is completed by modelling the placement of the selected protein structure in a volume comprising the solvent utilized in the molecular dynamics simulations. In the present embodiment, the protein structure is modelled as being centered in a rectangular box with periodic boundary conditions, having dimensions that exceed the outer boundaries of the protein by at least the radius of the cavity α. Alternatively, the protein structure may be modelled as being placed in any other desired volume.

In block 111, a plurality of points in and around the protein are selected. In the present embodiment, the space in and around the protein is partitioned into a lattice of points with a spacing b of 1 Angstrom between neighbouring points. In the alternative, the points may be selected from a lattice having spacing b between neighbouring points having any desired value. In the further alternative, the points may be selected from a lattice having a spacing b between 0.25 to 10 Angstroms. In the yet further alternative, the points may be selected from a lattice having variable spacing with higher densities of spacing at desired regions in and around the protein.

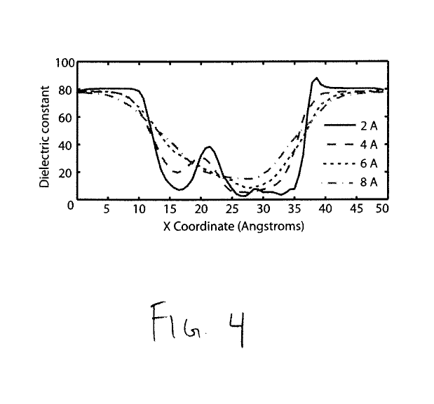

In block 113, for each point selected in block 111, a cavity is selected around the point. In the present embodiment, the cavity is a sphere having radius α of 1 Angstrom centered on its associated point. In the alternative, the radius α of the cavity may be any desired value. In the further alternative, the radius a may be selected between 1 to 10 Angstroms. In the yet further alternative, the radius a may be selected between 2 to 5 Angstroms. In the yet further alternative, the cavity may comprise other shapes and the Equations described above, for example Equations (3) to (21), may be modified accordingly to adapt to these other shapes. In the yet further alternative, the cavity radius a may be an adjustable parameter. A smaller value of a provides a more local description of the dielectric response of the protein but suffers from the application of a macroscopic description to the atomic-scale behavior within a smaller cavity. Conversely, a larger value of a may capture the effective macroscopic response of a protein region but conceal important shorter-length phenomena. For example, see FIG. 4 depicting the permittivity on a line through the middle of ubiquitin for various cavity radii a.

In an alternative embodiment, the choice of cavity radius may be used to determine the spacing of the plurality of points. In the further alternative, the radius of the cavity a is selected to be greater than twice the spacing b between neighbouring points. In one example, it was found that once the spacing b between neighbouring points is ¼ of the cavity radius a, the permittivities of the cavities determined using method 100 no longer change with an increasing density of points.

In block 115, for each cavity selected in block 113, a permittivity model of the permittivity inside the cavity, [symbol] ₂, is determined based on the permittivity outside the cavity, ∈₁, the electronic polarizability inside the cavity, α, and the nuclear polarizability inside the cavity, [symbol] . In the present embodiment, the permittivity model for each cavity is determined by applying Equation (21) to the cavity.

For a given cavity, the permittivity inside the cavity, 2, depends on the permittivity outside the cavity, ∈₁, which in turn depends on the pemittivities inside other cavities surrounding the cavity. Thus, to solve for the permittivities inside the cavities, the permittivities inside the cavities are iteratively determined as described in blocks 117 to 125.

In block 117, for each cavity, an initial permittivity inside the cavity and an initial permittivity outside the cavity are selected. In addition, an initial cavity is selected.

In block 119, the permittivity outside the selected cavity is determined based on the average permittivity within a selected volume outside the cavity. The selected volume is defined as the volume inside a sphere of radius a+v and outside the cavity, wherein a is the radius of the cavity and v is an additional radius beyond the outer surface of the cavity. In the present embodiment, a is 1 Angstrom and v is 1 Angstrom. In the alternative, v may be any other desired value. In the further alternative, v may be selected between 0.5 to 5 Angstroms. In the yet further alternative, v may be selected such that at least four points are contained in the selected volume. The average permittivity within the selected volume is determined by identifying points contained in the selected volume and averaging the permittivities inside cavities associated with such points. In cases where the cavity lies near the boundary of the protein-solvent system, the portion of the selected volume that lies outside the boundary of the protein-solvent system is defined as having the permittivity of the solvent, and this portion is incorporated into the determination of the average permittivity in the selected volume on a proportionally weighted basis. Alternatively, the average permittivity within the selected volume may be determined by other suitable methods, such as, for example, using a constant value, or a linear combination of average solvent and protein relative permittivities in proportion to the surface of the volume covered by solvent and protein.

In block 121, the permittivity inside the selected cavity is determined by solving the permittivity model for the cavity identified in block 115.

In block 123, a check is made as to whether the permittivities inside all of the cavities have been determined in the current iteration. If the permittivities of all of the cavities have been determined, the method advances to block 125, otherwise, another cavity is selected for which the permittivity inside the cavity has not been determined in the current iteration and the method repeats blocks 119 to 123.

In block 125, the permittivities inside the cavities determined in the current iteration are assessed to determine if the permittivities have converged to at least a minimum degree. If the permittivities have converged to at least a minimum degree, the method 100 is complete, otherwise the initial cavity is selected and a new iteration of blocks 119 to 125 is repeated. In the present embodiment, the minimum degree occurs when the all of the permittivities determined inside the cavities in the current iteration vary from the same permittivities determined in the previous iteration by less than 0.1% (or within three significant figures). In the alternative, the minimum degree of convergence may be selected as desired. In the further alternative, the minimum degree of convergence may be selected such that all of the permittivities determined inside the cavities in the current iteration vary from the same permittivities determined in the previous iteration by less than 5%. In the yet further alternative, other methods of determining the convergence as known in the art may be applied to determining the convergence of the permittivities determined inside the cavities.

At the completion of block 125, a map is formed comprising the localized dielectric properties in cavities formed around each of point. Thus, method 100 provides a map of the localized relative permittivity for each point in an around the protein. The localized relative permittivity at any location in the protein-solvent system may be determined by interpolation from the relative permittivities determined for surrounding points by method 100.

System for Determining Localized Dielectric Properties of a Protein

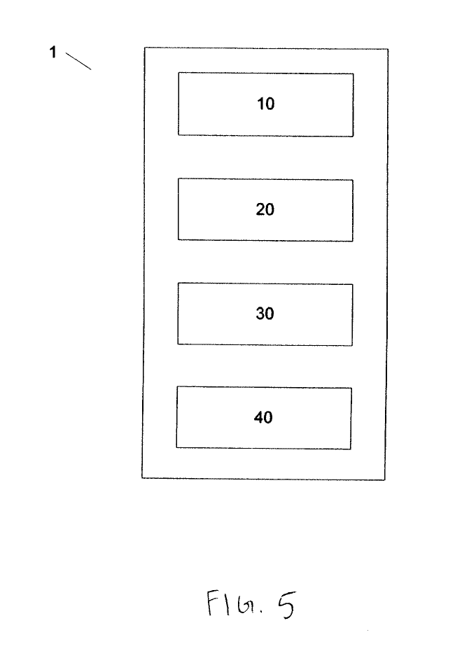

Referring to FIG. 5, in another embodiment, a system 1 for determining localized relative permittivity at points in and around a protein is shown comprising an input unit 10, a dipole identification unit 20, a partitioning unit 30, and a permittivity computation unit 40. In an alternative embodiment (not shown), the system 1 may include an application unit that applies determined localized relative permittivities in solving problems, as described in more detail below. The system 1 is configured to implement and perform the blocks of method 100 as described above. While the system 1 is described as being applied to determine the localized dielectric properties of a protein, it is to be understood that system 1 is not limited to being applied to proteins, and may be applied to any suitable molecule or system of molecules.

In the present embodiment, the system 1 comprises a computer (e.g., a computer system, computing system, or the like) having a computer processor and memory medium (not shown). The memory medium contains statements and/or instructions stored thereon that, when executed by the processor, provide the functionality of the input unit 10, the dipole identification unit 20, the partitioning unit 30, and the permittivity computation unit 40 described herein. In alternative embodiments, the input unit 10, the dipole identification unit 20, the partitioning unit 30, and the permittivity computation unit 40 may be comprised of one or more processors and memories (or other storage mediums) located at one more locations communicating through one or more networks. The processors may be comprised on one or more computers, application specific circuits, programmable logic controllers, field programmable gate arrays, microcontrollers, microprocessors, graphics processing units, virtual machines, electronic circuits and other suitable processing devices. Further, the memories may be comprised of one or more random access memories, flash memories, read only memories, hard disc drives, optical drives and optical drive media, flash drives, and other suitable computer readable storage media.

The input unit 10 is configured to obtain a plurality of frames from an atomic-resolution molecular dynamics simulation as described in block 101 of method 100. In addition, the input unit 10 is configured to receive operational parameters for configuring the operation of the system 1 and the application of method 100, such as, for example, parameters defining the lattice of points, cavity parameters, the molecular model, parameters defining the selected volume outside each cavity for determining the permittivity outside the cavities, the initial permittivity inside and outside each cavity, parameters defining the minimum degree of convergence, and other suitable parameters. In the present embodiment, the input unit 10 receives frames and the operational parameters by reading configuration data stored in the memory of the system 1. In the alternative, the input unit 10 may receive the frames and the operational parameters through any suitable apparatus or method, such as, for example, manual entry through a keyboard, or accessing data in a remote server. In the further alternative embodiment, the operational parameters are predefined in the system 1 and the input unit 10 solely receives the frames.

The dipole identification unit 20 is configured to: identify dipoles in each frame, determine the location and orientation of each dipole in each frame, and determine the correlation of the deviation of the dipoles over the frames, as described in blocks 103 to 107 of method 100.

The partitioning unit 30 is configured to: select a molecular model, select the plurality of point in the molecular model, and for each point, select a cavity around the point, as described in blocks 109 to 113 of method 100.

The permittivity computation unit 40 is configured to: determine a permittivity model for each cavity, select initial permittivities inside and outside each cavity, and iteratively determine the permittivity inside each cavity, as described in blocks 115 to 125 of method 100.

Conversion Between Tensorial and Scalar Permittivity

Solvation energy of a protein may be determined by applying the Poisson-Boltzmann equation to the determined relative permittivity of a protein. However, currently there are no available Poisson-Boltzmann equation solvers that accept a tensorial description of the permittivity inside a protein. Until such time that a Poisson-Bolztmann equation solver that accepts tensorial descriptions of permittivity is developed, the tensorial permittivities determined using the methods and systems described above may be converted to a scalar equivalent that attempts to replicate the behaviour of the tensor. Appropriate methods for converting the tensor ∈₂ to the scalar ∈ may vary from protein to protein. In one method, the transmission of free charge fields into an anisotropic dielectric depends on the geometric mean of the relative permittivities in each direction. That is, if λ₁, λ₂, and λ₃, are eigenvalues of ∈₂, the equivalent scalar ∈ may be determined by:

∉=(λ₁λ₂λ₃)^{1/3}. (22)

Alternatively, the equivalent scalar may be determined by either Equations (23) or (24), below, or by using other suitable equations.

$$\begin{matrix}ɛ = ( {λ}_{1} + {λ}_{2} + {λ}_{3} ) / 3 & ( 24 ) \\ ɛ = 3 / ( \frac{1}{{λ}_{1}} \cdot \frac{1}{{λ}_{2}} \cdot \frac{1}{{λ}_{3}} ) & ( 25 )\end{matrix}$$

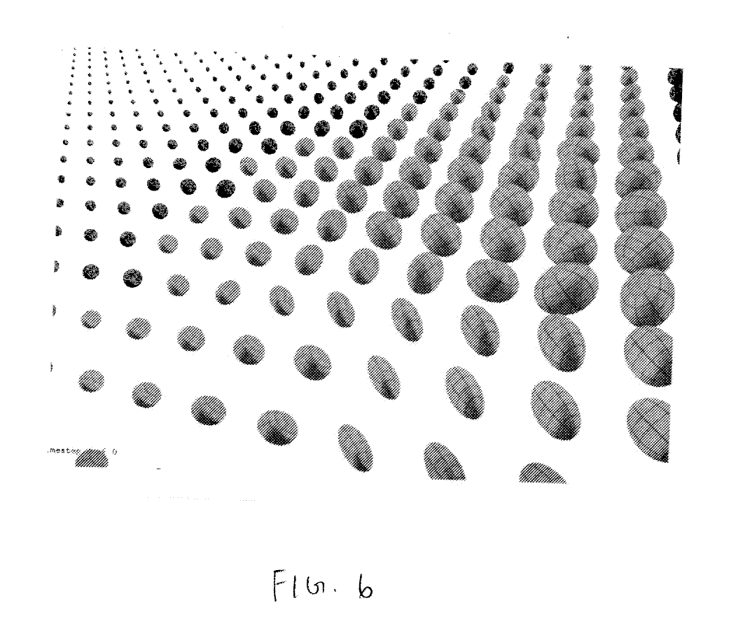

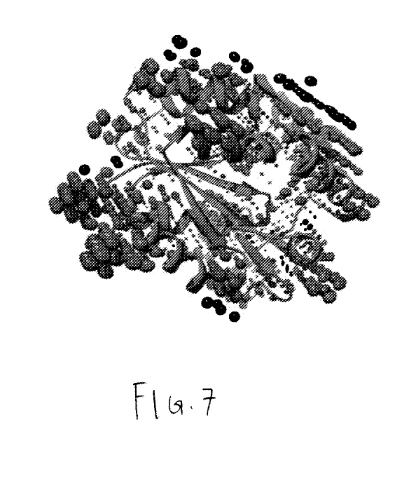

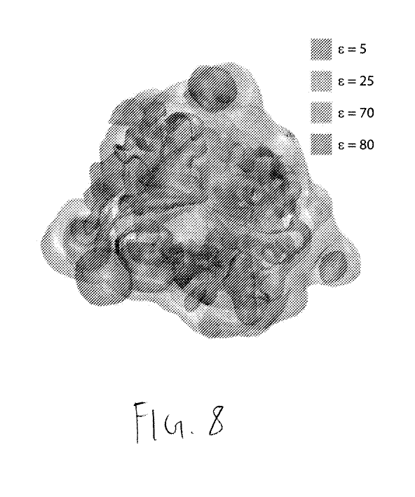

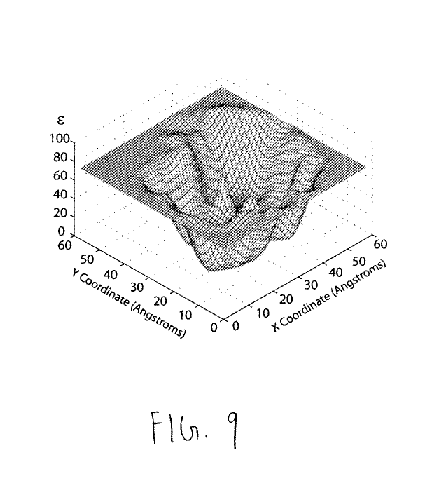

FIG. 6 shows the tensor dielectric produced by this invention on a cross section through the geometric centre of the protein ubiquitin (Protein Data Bank entry 1UBQ), with the reciprocal of the eigenvalues representing the orientation and magnitude of the various ellipsoids principal axes. FIG. 7 shows the anisotropic nature of the protein dielectric near the surface of the protein adenylate kinase. FIG. 8 shows iso-dielectric surfaces after converting the tensor dielectric constant into an effective scalar dielectric constant for adenylate kinase using Equation 22. FIG. 9 shows a plot of the effective scalar dielectric constant for adenylate kinase on a cross section through the molecule.

First Exemplary Application

One conventional assumption in electrostatic theory is to treat protein and solvent as a biphasic system, with two different constant values of the dielectric permittivity inside and outside the protein. Protein dielectrics in this formulation may range from ∈≈2 for PARSE parameter sets (comprising a set of physical constants and partial charges for atoms within a protein used for simulating protein energetics and dynamics) to ∈≈4 from bulk measurements of anhydrous protein on application of Kirkwood-Frölich theory to an idealized protein to ∈≈20 for best agreement with the experimental pKₐ's of titrable groups in proteins. Poisson-Boltzmann solvers are typically sensitive to the nature and position of the boundary separating protein and solvent in biphasic formulations, which calls for a more general inhomogeneous treatment. In one example, the effect of a relative permittivity determined by method 100 was investigated. A cavity radius of 3 Angstroms was utilized for a selection of 21 proteins from the Protein Data Bank chosen to represent a diverse selection of structural motifs, namely, PDB IDs: 1ADS, 1AKY, 1AKZ, 1AMM, 1ARB, 1BFG, 1CEX, 1DIM, 1EDG, 1MLA, 1ORC, 1PHC, 1PTX, 1RIE, 1RRO, 1TCA, 2AYH, 2DRI, 2END, and 3PTE.

The electrostatic energies of all salt bridges in this set of proteins were found by solving the linear Poisson-Boltzmann equation on a 97³ mesh in a water solvent containing 150 mM NaCl with the software package APBS. Both the heterogeneous local dielectric determined using method 100 and a traditional stepwise dielectric with a protein dielectric of 4 and a water dielectric of 78 were used to provide a direct comparison between the method 100 and the conventional approach. Two charged side chains or backbone termini were taken to form a salt bridge if their charged groups were within 5 Angstroms each other, whether their charges were alike or different. The salt bridge energy was calculated as the excess energy of charging a pair of atoms over charging each of the atoms independently: a function of the fully charged protein energy E_{AB}, the energy E₀ of the protein with both groups participating the salt bridge decharged, and the energies of the protein with only one or the other group charged, E_{A} and E_{B}, so that:

ΔE_{sb}=E_{wt}+E_{AB}−(E_{A}+E_{B}). (30)

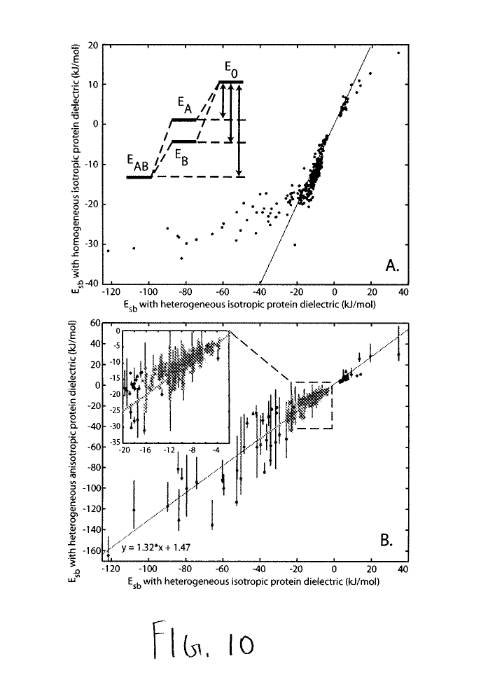

Although slightly more complex than the usual approach of taking E_{sb}=E_{AB}−E₀, this method isolates the mutual interaction energy of charges participating in the salt bridge from their solvation energy in the general protein milieu. This approach was applied to all 370 salt bridges in the above set of proteins. As shown in FIG. 10, the correspondence between the salt bridge energies calculated with the heterogeneous dielectric determined using method 100 and a traditional homogeneous dielectric is fairly linear, with a correlation coefficient of R=0.85 between the energies from the two methods. However, the best fit line with a protein dielectric of 4 has a slope of 0.63, so this choice of protein permittivity significantly overstates the energy of most salt bridges. By adjusting the protein permittivity to 10 instead, the line of best fit has a slope of 1.16, producing better agreement with the heterogeneous method 100. Fractional adjustment of the homogeneous protein permittivity would yield a best fit line of slope 1.00. It was found that the correspondence between the homogeneous method and the heterogeneous method 100 is best for weak salt bridges with energies around zero (this is intuitively sensible as these salt bridges are almost completely solvated by water, making the choice of protein dielectric less important). It was found, however, significant divergence in the calculated energies of stronger salt bridges which are likely to play a larger role in the stabilization of native structure. In particular, those salt bridges that form in the hydrophobic core of the protein, although relatively uncommon, have their energies underestimated by use of a homogeneous protein dielectric that gives the best fit overall for the full set of salt bridges. In principle, for each salt bridge in a protein there may be a choice of homogeneous protein dielectric that would give the same energy as the heterogeneous dielectric determined using method 100, however, this choice of dielectric is not obvious a priori. The heterogeneous method 100 may appropriately describe without assumption the local environment of each salt bridge, improving the validity of comparisons between salt bridges at different sites in a protein.

Second Exemplary Application

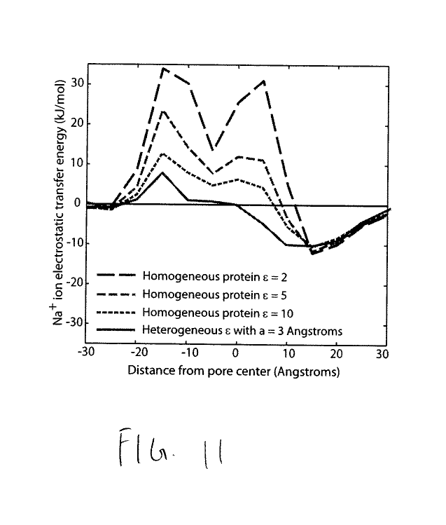

Another frequent use of continuum electrostatics calculations is to model the transit of an atom through a membrane channel. The energy of the ion at different sites in the channel describes the barrier to be overcome during the kinetics of ion travel. To test the heterogeneous protein dielectric method 100 in an ion channel system, the dielectric map was computed for the acetylcholine receptor pore based on the electron microscopy structure (1OED). The linear Poisson-Boltzmann equation was solved with APBS under the same conditions of water dielectric and ionic concentration as for the salt bridge energy calculations above. The transfer energy of a sodium ion at a position r along the central axis of the pore was determined by taking the energy of the ion and the protein together and subtracting from it the energy of the protein alone and the Born energy of the ion in free water: E_{transfer}(r)=E(r)−E(∞). This calculation was performed for several choices of homogeneous protein dielectric (∈=2, 5, and 10) and for the heterogeneous dielectric method 100 using a cavity radii of 3 Angstroms (the radius of the ion channel). The energy profiles of the ion as a function of transit through the pore are shown in FIG. 11. It was found that as the homogeneous protein ∈ increases, the energy barrier to ion transit decreases. Overall there is a much higher energy cost to ion transit for the homogeneous method, with a peak barrier height of 6 kT for a homogeneous ∈ of 10, compared with a peak barrier height of 3.5 kT from the heterogeneous method 100. It is believed based on a molecular dynamics simulation of the 1OED structure, that it represents the pore in the “closed” state, so it is expected that a potential energy barrier to ion passage through the pore is consistently observed. In this channel the barrier seems to derive from the presence of hydrophobic residues at the constriction point in the channel (coinciding with the lowest dielectric in the heterogeneous theory), forcing the ion to pass through a region of low dielectric as can be seen in FIG. 11 at the maximum of the transfer energy function.

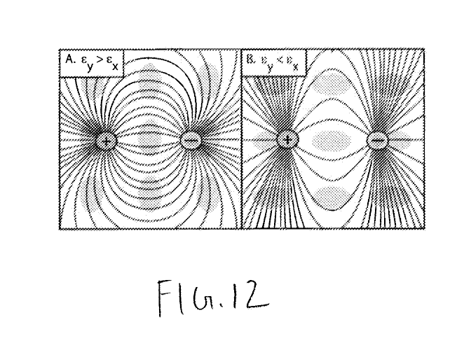

The calculations using APBS capture the heterogeneity of the calculated dielectric but not its anisotropy (since the relative permittivity in these simulations must be scalar). This anisotropy, which is most pronounced in the protein interior, is a feature of protein dielectric behavior that enables the modulation of attractions and repulsions between closely spaced charged groups in a way that may maximize the stability or utility of the protein. As seen in FIG. 12, the orientation of an anisotropic dielectric interposed between charged groups affects the local field geometry so as to amplify field components parallel the lesser axis of the dielectric tensor and attenuate those parallel the greater axis. In regions of proteins containing many charged residues of like and unlike charge, such as an active site or binding pocket, adjustment of the orientation of the dielectric tensor may increase attraction energies and decrease repulsion energies (or vice versa as needed) to improve stability while maintaining necessary charges in a fixed geometry. Indeed, residues near charged groups may be evolutionarily selected to favor those with anisotropic fluctuations in a preferred direction.

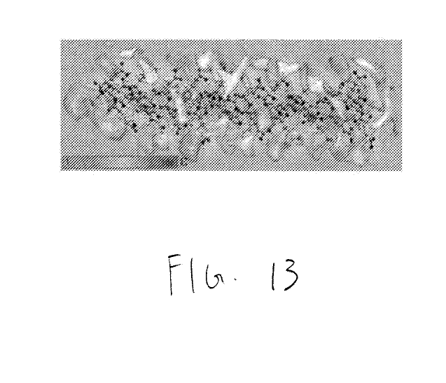

It was found that the application of the heterogeneous protein dielectric method 100 results the presence of regions with relative permittivity exceeding that of water on the surface of the protein, as can be seen in FIGS. 8 and 13. The solvation energy of a charged group varies inversely with the solvent relative permittivity, so the presence of these regions lowers the potential energy of protein surface charges and enhances protein stability. They arise from the presence of charged or polar groups with large dipole moments on the protein surface that can fluctuate extensively, as there are fewer native steric constraints restricting their motion. Protein N- and C-termini, with high flexibility and a net charge, are common sites for this effect. Large values of the relative permittivity approaching that of the solvent have been observed on the surface of proteins, and values of the relative permittivity approaching 150 have been seen for salt bridges on the surface of barnase. Dielectric values much greater than water have also been observed just outside the charged head groups of lipid bilayers. Having the surface of the protein surrounded by this region of high relative permittivity would attenuate the projection of electric fields from solution into the protein and vice versa, potentially reducing electrostatic attractions or repulsions between nearby proteins. This may reduce the unfavorability of having protein regions of like charge near to each other (enabling a higher intracellular protein concentration) while reducing the likelihood of aggregation between oppositely charged protein regions.

Third Exemplary Application

Misfolded prion protein is the causative agent for a unique category of human and animal neurodegenerative diseases characterized by progressive dementia, ataxia, and death within months of onset (Prusiner 1998). These include Creutzfeldt-Jakob disease (CJD), fatal familial insomnia, and Gerstmann-Sträussler-Scheinker syndrome in humans, bovine spongiform encephalopathy in cattle, scrapie in sheep, and chronic wasting disease in cervids. Unlike other infectious conditions that are transmitted by conventional microbes, the material responsible for propagation of prion diseases consists of an abnormally folded conformer of an endogenous protein, possibly in complex with host nucleic acids or sulfated glycans (Caughey 2009). Soluble, natively-folded monomers of the prion protein (known as PrP^{C}) may adopt an aggregated protease-resistant conformation known as PrP^{Sc} that is capable of recruiting additional monomers of PrP^{C} and inducing them to misfold in a process of template-directed conversion. This results in ordered multimers of prion protein that, when fractured, act as additional seeds to propagate the misfold through the reservoir of PrP^{C} present in brain. Although the conversion process may be initiated by an infectious inoculum of PrP^{Sc}, it may also arise spontaneously or due to mutations in the gene coding for PrP that predispose to misfolding.

Structurally, PrP^{C} is a glycophosphatidylinositol-anchored glycoprotein of 232 amino acids comprising an N-terminal unstructured domain and a C-terminal structured domain of 3 a-helices (hereafter referred to as α1, α2, and α3 in order) and a short two-stranded antiparallel β-sheet (made of strands β1 and β2), while PrP^{Sc} has substantially enriched β content speculated to form a stacked β-helix (Govaerts 2004) or extended β-sheet (Cobb 2007) conformation in the amyloid fibril.

At a molecular level PrP misfolding is a physico-chemical process, with the propensity to misfold determined by the free energy difference between folded and misfolded states and the magnitude of the energy barrier separating them. As in any protein system, electrostatic effects make significant contributions to the energies of the various states and take two forms: salt bridge energy due to spatial proximity of charged groups within the native protein, and solvation/self energy due to field energy storage in the ambient protein and water dielectric media. A priori, it is expected that electrostatic effects generally favour the well-solvated monomeric PrP^{C} over the more hydrophobic amyloid PrP^{Sc}, since formation of PrP^{Sc} necessitates disruption of salt bridges in the native structure (although this may be compensated for by the formation of alternative salt bridges in PrP^{Sc}) and transfer of some charged groups into an environment of lower permittivity, both of which are energetically costly. However, these penalties on formation of PrP^{Sc} are counterbalanced by hydrogen bonding, hydrophobic, and possibly entropic contributions that favour the amyloid form (Tsemekhman 2007). Regional variation in the electrostatic transfer energy to water and amyloid may be useful in predicting participation in the amyloid core of PrP^{Sc}. Furthermore, several of the causative mutations for familial prion disease involve substitution of charged residues for uncharged residues (such as the D178N mutation responsible for fatal familial insomnia or familial CJD, depending on mutant allele polymorphism status at codon 129) or charge reversal of a residue (such as E200K, the most common mutation in classical familial CJD) (Kovacs 2002), offering an indication of the importance of electrostatic effects in the misfolding process. More broadly, it has been found that changes in the charge state of a mutant protein compared to wild-type relate to its tendency to form aggregates (Chiti 2003), and the aggregation propensity of a polypeptide chain is inversely correlated with its net charge (Chiti 2002); similarly, aggregation propensity is maximal at the protein iso-electric point where the net charge is zero (Schmittschmitt 2003). Intrinsically unstructured proteins tend to have a high net charge (Uversky 2000), which increases the electrostatic cost for the system to condense into the folded structure.) Sequence correlations between charged groups may affect the kinetics of amyloid formation as well (Dima 2004).

The role of salt bridges in prion disease has been investigated previously by molecular dynamics simulation (MDS) and experimental studies of mutant protein. MDS of human PrP^{C} has identified salt bridges that play a role in stabilization of the native structure (Zuegg1999). Other MDS studies of the R208H mutation, which disrupts a salt bridge with residues D144 and E146 of α-helix 1, have shown that it results in global changes to the backbone structure (Bamdad 2007). Experimentally, the E200K mutant of PrP^{C} has been shown through calorimetry to be 4 kJ/mol less stable than wild type (Swietnicki 1998). Mutation of two aspartates participating in al intra-helix salt bridges to neutral residues increases misfolding fourfold in cell-free conversion reactions under conditions favouring salt bridge formation (Speare 2003). Complete reversal of charges in α1 appears to inhibit conversion, possibly by preventing docking of PrP^{C} and PrP^{Sc} (Speare 2003). The pH dependence of charge interactions in PrPC has also been investigated to identify those most sensitive to pH changes (Warwicker 1999); as increased PrP^{C} misfolding rate at low pH has not been observed.

In what follows method 100 was applied to determine the energies for all salt bridges in 12 molecular species of prion protein and the transfer energy for all residues in these proteins into a hypothetical protein amyloid core.

Twelve structures of various species and mutants of PrPC were selected from the Protein Data Bank (PDB), including human (1QLZ and 1QLX), cow (1DX0), turtle (1U5L), frog (1XU0), chicken (1U3M and 1U5L), mouse (1AG2, 1XYX, 1AG2, and 1XYX), dog (1XYK), pig (1XYQ), cat (1XYJ and 1XYQ), wallaby (2KFL) and the human mutants (D178N, 2K1D) (Mills 2009) and E200K (1FKC). They were taken as starting points for 5 ns all-atom molecular dynamics simulations (using the CHARMM force field version C31B1 (CHARMM 1983) with explicit pure solvent water (no salt), periodic boundary conditions, particle mesh Ewald electrostatics, a timestep of 2 fs, and a Lennard-Jones potential cutoff distance of 13.5 Angstroms. The basic residues (ARG and LYS) were protonated, while the acidic residues (HIS, ASP, and GLU) were deprotonated to reflect ionization conditions at pH 7. The system was first minimized for 200 time steps before starting the simulation.) Snapshots of the simulations were taken every 2 ps to build up an ensemble of equilibrium conformations for each protein. The dipole moments μ of all residue side chains and backbones were calculated at each snapshot and used to obtain the correlation coefficients:

$${R}_{ij} = \frac{〈 {μ}_{i} {μ}_{j} 〉}{\sqrt{〈 {μ}_{i}^{2} 〉 〈 {μ}_{j}^{2} 〉}}$$

for all pairs of Cartesian dipole components μᵢ and μⱼ, where the angle brackets denote an average over all snapshots (the thermal average). The matrix R of correlation coefficients was diagonalized to isolate the normal modes of dipole fluctuations, which describe the response of charged groups to perturbations around equilibrium. The R matrix for each protein was used to calculate the local dielectric map (Guest et al. 2009). These dielectric maps were then taken as input for the Poisson-Boltzmann solver APBS (APBS) to solve the linearized Poisson-Boltzmann equation on an 97³ mesh in 150 mM NaCl, again with periodic boundary conditions, to obtain the electrostatic energies required below. Atomic radii were assigned according to the CHARMM force field by the program PDB2PQR (Dolinsky 2004). The often-used simplifying approximation of a constant internal protein dielectric constant of 4 and water dielectric constant of 78 was employed for comparison (Nussinov 1999).

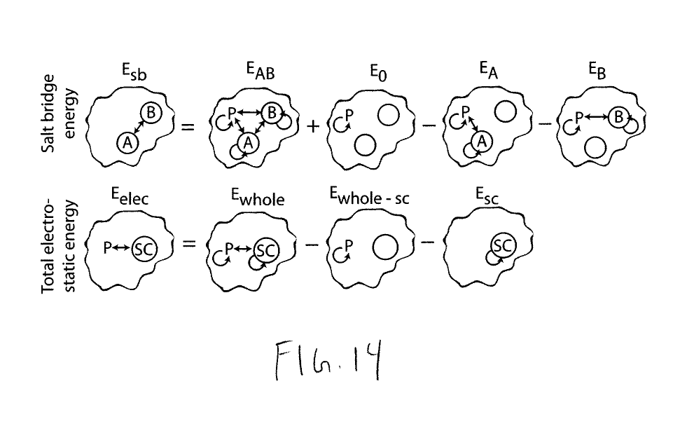

Ion pairs in the set of proteins were identified by searching all pairs of charged atoms for those with charged groups within 12 Angstroms of each other, whether the charges were alike or different. The energy of each salt bridge or ion pair was determined by a mutation cycle designed to isolate the charge interaction energy from the energy in the surrounding dielectric milieu as shown in FIG. 14. For charged groups A and B, their salt bridge energy E_{sb} was taken to be a function of the energy of the protein system with both charges in place, E_{AB}, with one or the other charge removed, E_{A} and E_{B}, and with both charges removed, E₀, as follows:

E_{sb}=E₀+E_{AB}−(E_{A}+E_{B}).

Here, E₀ contains only the self energy of the part of the protein not including A and B (labelled P in FIG. 14), while E_{AB} contains the self energies of A, B, and P as well as the pairwise interaction energies between A and B, A and P, and B and P. E_{A} contains the self energies of A and P and their interaction energies E_{B} is analogous. Combining the terms as shown causes all the energies except the interaction energy of A and B to cancel.

Another cycle, also shown in FIG. 14, was used to determine the total contribution of each residue to the electrostatic energy of the protein, E_{elec}. For each side chain in the protein, the electrostatic energies of the side chain E_{sc} and the protein lacking the side chain E_{whole-sc} were calculated in isolation in the protein dielectric environment and subtracted from the electrostatic energy of the intact protein E_{whole}:

E_{elec}=E_{whole}−E_{sc}−E_{whole-sc}.

The terms E_{sc} and E_{whole-sc} contain the self energies of the side chain and rest of the protein respectively, and E_{whole} contains these self energies as well as the interaction energy of the side chain with the rest of the protein. Subtracting the terms as shown causes the self energies to cancel, leaving only the interaction energy between the side chain and the protein. This energy can be thought of as the electrostatic potential energy of a residue in the protein.

To approximate the electrostatic energy of residue transfer into a hydrophobic, low dielectric environment like the core of a PrP^{Sc} amyloid, the energy E(∈_{PrPC}) of a residue in the dielectric environment of PrP^{c} was compared to the energy E(∈_{PrPSC}) of the residue in a homogeneous dielectric of ∈=4, which describes the dielectric response in the interior of a bulk amyloid protein phase. Since the nature of monopole fields in the PrP^{Sc} structure is unknown, interactions between charged residues are omitted from the calculation, so the transfer energy reflects only changes in the dielectric environment. For a given residue, the dielectric contribution to the transfer energy Eₜᵣₐₙₛ is:

Eₜᵣₐₙₛ=E(∈_{PcP}_{^{Sc}})−E(∈_{PrP}_{^{C}}).

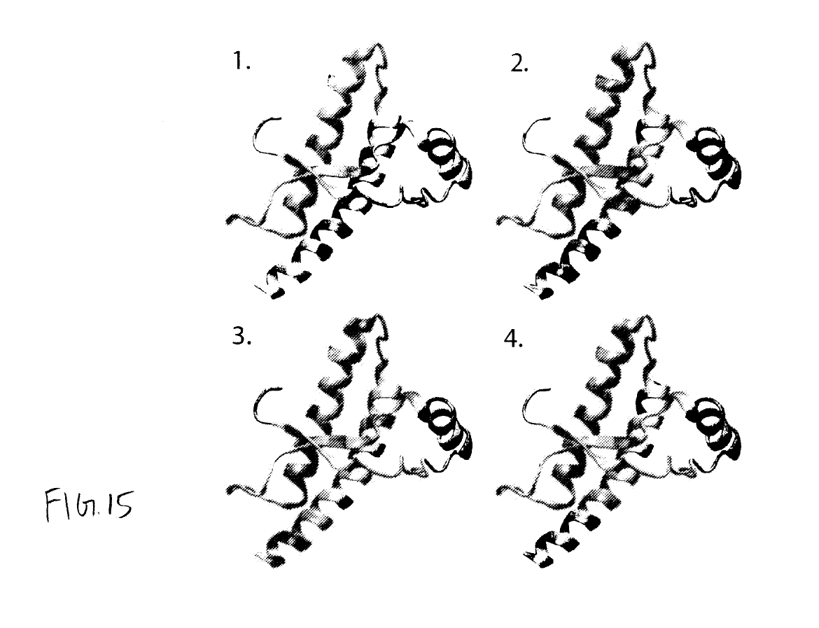

The modes obtained by diagonalizing the correlation matrix R provided above generally involved several parts of the molecule; correlations were not limited to residues close in space or sequence. This is consistent with phonon transmission of perturbations at one site throughout the molecule by strong steric coupling effects through solid-like elastic moduli. The four largest-amplitude dipole modes for human PrP are shown in FIG. 15. Dipole fluctuations were not qualitatively different between species, but different regions of the molecule exhibited characteristic motions. The two long alpha helices 2 and 3 exhibited primarily synchronous motion, with the helices rocking back and forth together as a unit. Nonetheless, some dipoles in the helices exhibited contrary motion. Alpha helix 1 did show some autonomy from the rest of the structure and tended to fluctuate as a group.

Motion of the beta sheet was prominent in several of the modes. Two patterns were observed: a see-saw motion in which one strand tilts up as the other tilts down with both strands pivoting about the middle of the strands, and an in-out motion in which the outer beta strand β1 and the N-terminal part of α2 move synchronously away from the inner beta strand β2. The first motion seen in modes 2 and 3 in FIG. 15, while the second motion seen in other lesser-amplitude modes. This is compatible with NMR observations of the beta sheet, which show slow exchange between a range of conformations (Liu 1999, Viles 2001). In the NMR experiments, motion of the beta strands was observed on a time scale of microseconds, while these simulations only spanned nanoseconds, but both are indicative of some degree of conformational flexibility in the beta sheet.

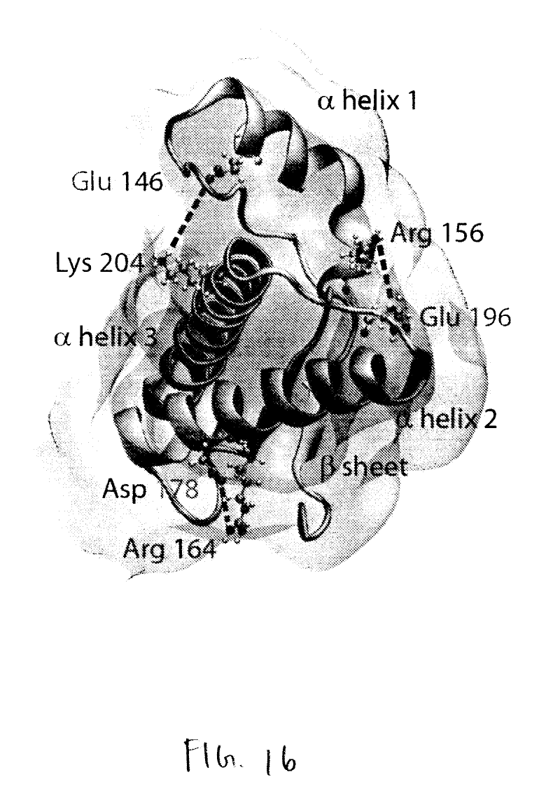

The PrP structures analysed contained a diverse set of salt bridges, ranging from moderately attractive to weakly repulsive. Structurally, the salt bridges identified could be divided into local and nonlocal by the proximity in sequence of the participating residues. Local salt bridges, like Asp148-Glu152 in α1, Asp208-Glu211 in α3, and Arg164-Asp167 between β2 and the following loop serve to stabilize secondary structural elements of the protein, while nonlocal salt bridges like Arg156-Glu196, Arg164-Asp178, and Glu146-Lys204 help to hold these elements together in the overall tertiary fold. FIG. 16 shows the position of these nonlocal salt bridges in bovine PrP.

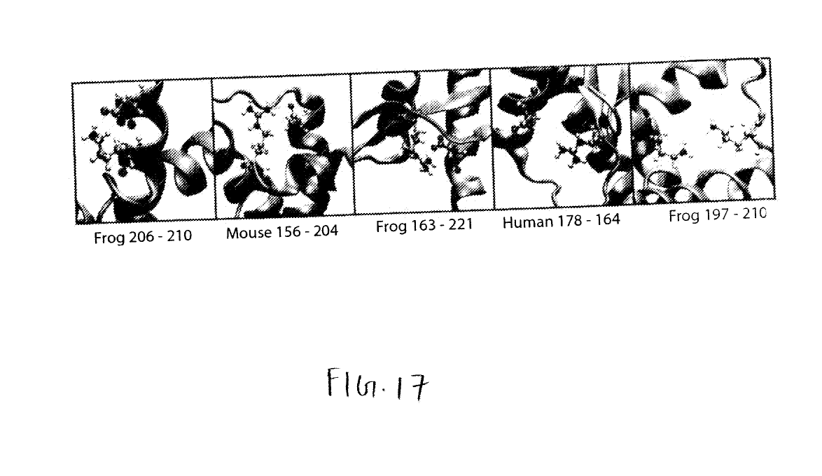

Many of the salt bridges identified were near the protein surface, where the high degree of solvation attenuates their strength; the strongest salt bridges were those best sequestered from solvent, for this places them in a dielectric environment that increases electric field strength. The strongest salt bridge of all, between residues 206 and 210 of frog PrP, features a special “two-pronged” geometry that enables the amino group of Lys 210 to associate with both carboxyl oxygens on Asp 206. Interestingly, two strong but intermittent salt bridges were found to be present in human 1QLZ between the C-terminal arginine and residue 167 in the β2-α2 loop and residue 221 in α3. The substantial variation between members of the NMR ensemble at the C-terminus results in large motion of the arginine side chain, so that these salt bridges are only formed in a subset of conformers. Similarly, the ARG 164-ASP 178 salt bridge that helps to anchor the beta sheet to α2 and α3 were not present in all members of the 1QLZ NMR ensemble, although it was quite strong in the single 1 QLX structure. Although attractive salt bridges predominate, there were a number of repulsive salt bridges identified as seen on the left hand side of FIG. 17A, especially in α1 and α3, which are crowded with several charged residues. As demonstrated in the following section, despite the presence of these destabilizing interactions, no residue experiences a net repulsive potential as these unfavourable salt bridges are counterbalanced by the presence of other, stronger, favourable ones.

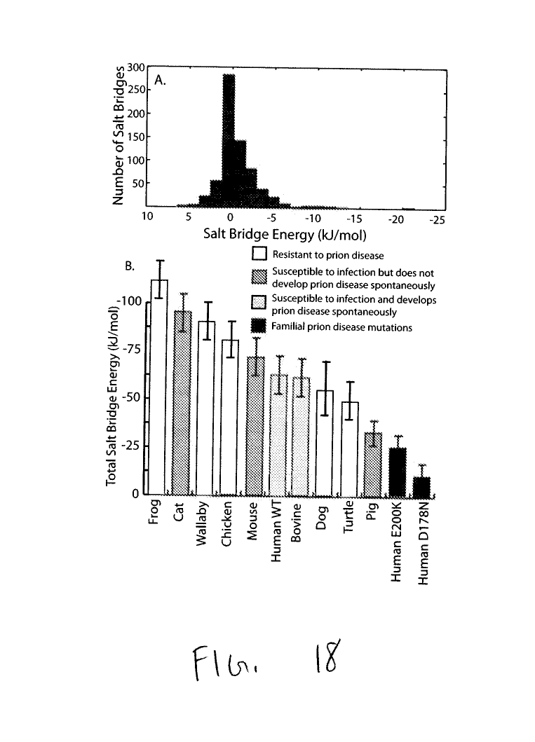

The total energies due to all salt bridges in each molecular species studied are shown in FIG. 18. Of note is the much reduced total salt bridge energy in the two human mutants, E200K and D178N, compared to any other structure. The categorization of species as susceptible or resistant to prion disease is somewhat approximate, but comparison of total salt bridge energy and disease susceptibility by Kendall's tau gives a value of tau=0.45, implying that the order of species by salt bridge energy and disease susceptibility are significantly concordant (p=0.046).) Overall, the effect of a heterogeneous dielectric was to moderate putatively strong salt bridges under the biphasic protein-water approximation for the dielectric function.

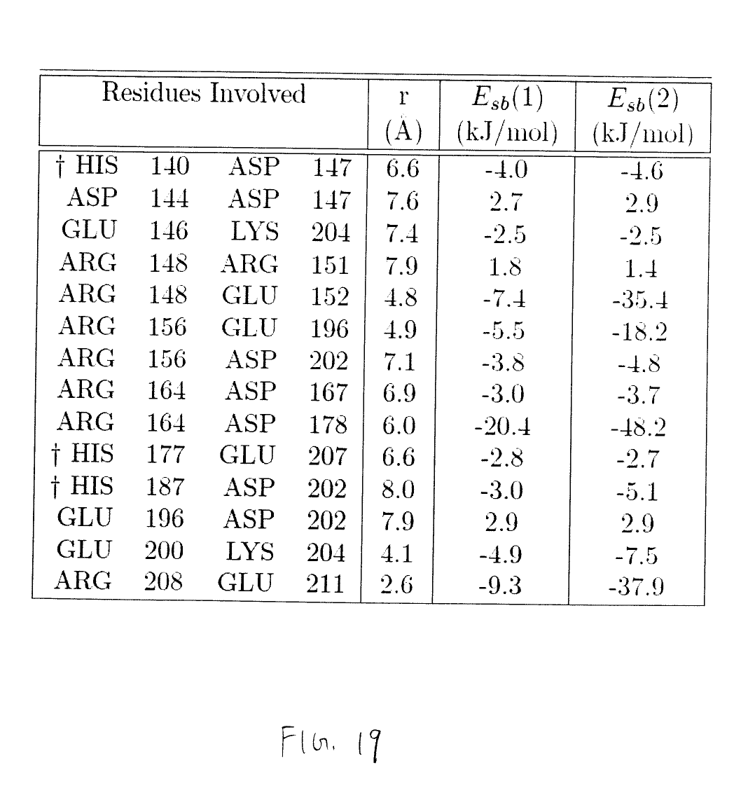

Salt bridges present at pH 7 were identified, but for human PrP an additional search was performed to identify salt bridges that would emerge at lower pH, since acidic conditions are known to drive PrP^{Sc} formation. Lower pH results in protonation of histidine residues to produce a positively charged species, which in human PrP enables the formation of three additional weakly attractive salt bridges (indicated by daggers in FIG. 19). While the dominant effect of lowering pH is to reprotonate acidic side chains, thus reducing electrostatic stability, this is partially compensated for by the formation of salt bridges involving histidine.

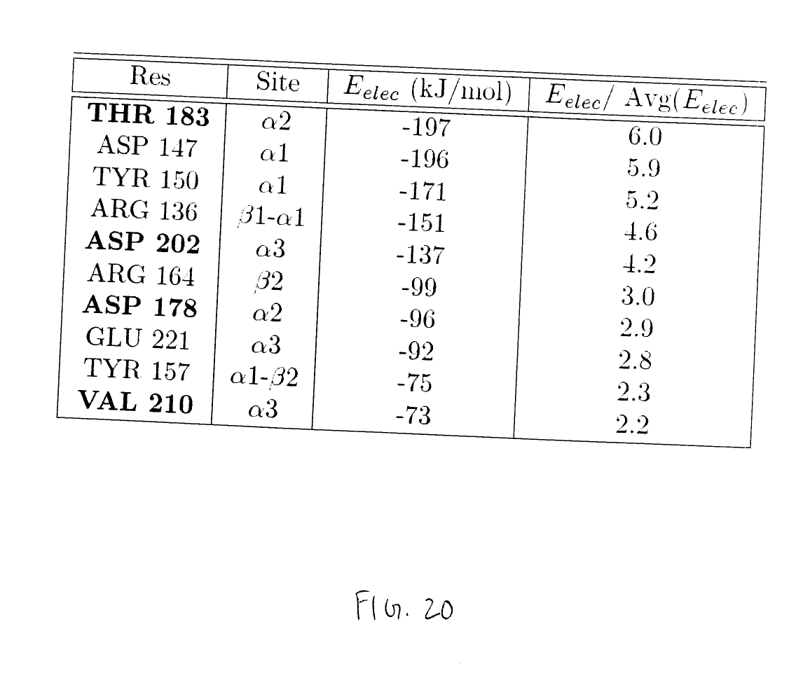

The salt bridge energies describe pairwise effects, but for mutational analysis it is useful to know the total contribution of each side chain to the stability of the protein. These energies approximate the electrostatic contribution to the energy change on mutation to a residue with a small nonpolar side chain like alanine. In practice, the side chain of each residue is removed from the protein. The total electrostatic energy of each residue in all prion proteins studied was less than or equal to 0, suggesting a strong degree of evolutionary selection toward residues that benefit stability in the folded conformation. Through electrically neutral, or nearly so, proteins have their internal dipoles oriented so as to lower the potential energy of every residue. In human PrP, the energies may be correlated to known pathogenic mutations: the residue with the greatest overall stabilizing energy, Thr183, is implicated in familial CJD by a T183A mutation (Kovacs 2002); this mutation has also been shown to radically reduce measured stability by urea denaturation (Liemann 1999). This residue, although not charged, is polar and more deeply buried in the hydrophobic core of the protein than any other charged residue, thereby enhancing the effect of dipolar attractions with its neighbors. Other residues that on mutation cause familial prion disease have especially high total electrostatic stabilizing energies, including D178 and D202. FIG. 20 gives the 10 human side chains with the greatest total electrostatic energies. Mutation of other residues in FIG. 20 may enhance the probability of developing misfolding-related disease.

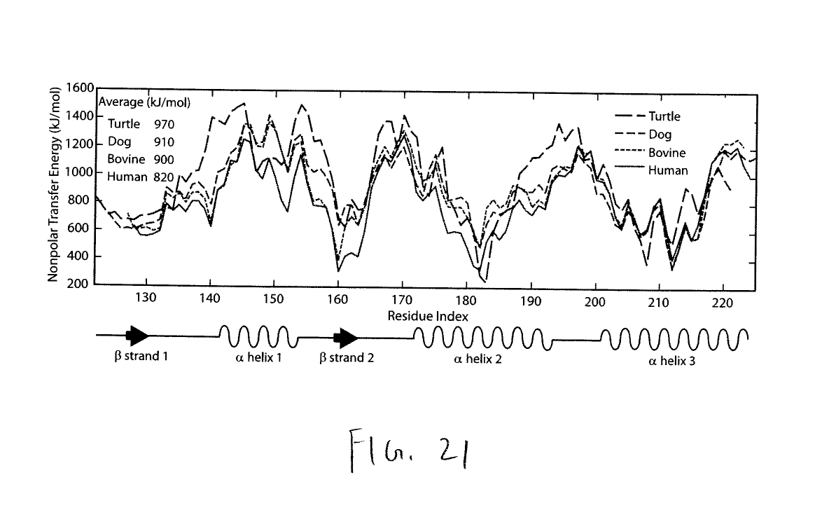

In forming the amyloid core of PrP^{Sc}, some residues must undergo the migration to a region of low dielectric constant. For highly charged residues, this transfer energy is prohibitively high and may thereby exclude their participation in the amyloid core, while for nonpolar residues the small electrostatic transfer energy cost is overcome by favourable solvation entropy changes. By mapping the transfer energy of each residue into a region of low dielectric approximating PrP^{Sc} amyloid, it is possible to predict the likelihood of recruitment for various PrP regions into the amyloid core, without the aid of specific dipole-dipole correlations as might be present in the amyloid. FIG. 21 shows the transfer energy from the PrP^{C} dielectric to a homogeneous dielectric of 4 for various species of PrP^{C}. The transfer energy to an aqueous environment would show an inverse pattern. A 7 amino acid summing window is applied because sequence heterogeneity causes large variation between adjacent residues, and individual residues cannot enter the amyloid core without placing their neighbors in it as well. The transfer energies in FIG. 21 are quite large, but including other terms in addition to the electrostatic energies considered here will reduce the magnitude of the total transfer free energy.

There is considerable variation in the transfer energy along the sequence, with the lowest barrier to dielectric transfer for the region between α1 and β2, the middles of α2 and α3, and α1. Conversely, α1, the loop between β2 and α2, and the loop between α2 and α3 show a formidable barrier to transfer. This overall pattern is well preserved among all PrP structures studied. Immunological studies have defined β2 as a PrP^{Sc}-specific epitope (Paramithiotis 2003), which presumably necessitates its surface exposure. In the human structure, β2 is located at the border between regions of low and high transfer energies, so it is possible that it is close in proximity to the amyloid core but protrudes sufficiently to be recognised by antibodies.

The overall contour of the transfer energy functions is similar for all PrP structures studied, but there is some variation that correlates with known infectivity data. As seen in FIG. 21, human and bovine share highly similar transfer energy profiles and are both susceptible to prion disease and interspecies transmission of disease, while non-mammalian turtle PrP that does not form PrP^{Sc} has a different profile, with a higher transfer energy barrier than cow or human over 4/5 of the sequence. PrP^{C} from dog, a mammalian species known to be resistant to prion infection (Polymenidou 2008), is intermediate between the human and turtle profiles. The average transfer energies correlate with a species' resistance to disease (FIG. 21 legend). Some other species, including chicken, turtle, and wallaby, have a qualitatively different transfer energy function.

Continuum electrostatics as a tool to examine protein behaviour has limitations, namely that it ignores the microscopic response of the system and thereby risks omitting subtle but important effects. However, by deriving the dielectric map from all-atom molecular dynamics simulations of the proteins of interest, the microscopic response was substantially incorporated, thereby improving the reliability of the energy estimates obtained. Previous theories have not reliably predicted the effective dielectric constant inside a protein, so values typically between 4 and 10 have been used as initial guesses. Stronger salt bridges in the interior tend to be better predicted by an interior dielectric of 4, which would then overestimate the strength of the more abundant salt bridges on the protein surface. An interior dielectric of 10 best predicts the strength of the abundant surface salt bridges, but would then underestimate the strength of the buried interior salt bridges. The heterogeneous dielectric method described herein makes it unnecessary to guess at the value of the dielectric inside a protein and also indicates that no single value in the interior is satisfactory. Quantum effects due to electronic polarizability may be added to this approach as further refinement. The conformational variability in the ensemble of NMR structures for each PrP molecule also introduces an inherent uncertainty in the calculation of electrostatic energies, which were treated by averaging salt bridge energies over all NMR ensemble members. The molecular dynamics relaxation methods, often done in the absence of counterions, may introduce uncertainty as well. Electrostatic considerations are relevant to many aspects of the prion question, from PrP^{C} dynamics and stability to PrP^{Sc} amyloid organization and templating. The above analysis has presented an analysis of salt bridge, electrostatic, and hydrophobic transfer energies that provides a useful perspective for understanding the structural vulnerabilities of PrP^{C}.

The method 100 and system 1 described above was used to determine the salt bridge energies, total residue electrostatic potential energies, and transfer energies into a low dielectric amyloid-like phase for 12 species and mutants of the prion protein. Salt bridges and self energies play key roles in stabilizing secondary and tertiary structural elements of the prion protein. The total electrostatic potential energy of each residue was found to be invariably stabilizing. Residues frequently found to be mutated in familial prion disease were among those with the largest electrostatic energies. The large barrier to charged group desolvation imposes regional constraints on involvement of the prion protein in an amyloid aggregate, resulting in an electrostatic amyloid recruitment profile that favours regions of sequence between alpha helix 1 and beta strand 2, the middles of helices 2 and 3, and the region N-terminal to alpha helix 1. It was found that the stabilization due to salt bridges is minimal among the proteins studied for disease-susceptible human mutants of prion protein. It was also found that, for the species studied, the average electrostatic binding potential correlates with a species' resistance to prion infection.

The exemplary applications for the method 100 provided above are intended to be exemplary in nature and demonstrative of the improved accuracy of Poisson-Boltzmann calculations using method 100. However, the utility of method 100 extends to any protein system in which electrostatics may play a role, such as, for example, protein interactions with polyanions like DNA or RNA, protein-protein recognition, oligomerization, and aggregation, and membrane protein transport and selectivity.

The foregoing embodiments may be used to study proteins of different sizes. In one embodiment, the minimum size for a given protein is two amino acid residues; the maximum size is not limited but for practical purposes may be set at 1000 amino acid residues, given current computational performance. In further alternative embodiments, the minimum number of polypeptides in the system is 1, and the maximum number is not limited but for practical purposes may be set at 10.

The output of the foregoing embodiments, specifically the relative permittivity at points in space in and around a biomolecular system, determines the electrostatic potential of the system, which may be calculated by solution of the Poisson-Boltzmann equation. Electric fields in and around the protein may then be determined from the gradient of the potential function. In calculations of electric fields and potentials in and around a protein, the current state of the art is to use constant dielectrics of 4 (Suydam, Snow, Pande, Boxer Science v313 p 200 2006) in the interior of the protein, which ignores variation due to regional differences in amino acid composition. The present invention explicitly accounts for these differences in the dielectric function, improving the accuracy of electrostatic potential calculations. This electrostatic potential determines the energies of protein-protein interactions and the energies of molecular binding to the protein or other biomolecules, which are applications of the foregoing embodiments. Additionally, and without limitation, other applications of the foregoing embodiments as discussed in more detail below include use in: modelling protein unfolding; calculation of equilibrium acid/base dissociation constants for ionizable groups in a protein (specifically the N terminus, the C terminus, and the side chains of glutamic acid/glutamate, aspartic acid/aspartate, cysteine, histidine, tyrosine, lysine, and arginine); prediction of protein-protein interactions; calculation of ligand docking energies for computer-aided drug design; and calculation of interaction energies between all charged groups within a protein, and their enthalpy of transfer into different solvent conditions. Additionally, the dielectric function can be used as an implicit solvation model in molecular dynamics. The application unit (not shown) of the system 1 may be configured to apply the foregoing embodiments as described above.

Application to Protein Unfolding

In one exemplary application of the foregoing exemplary method and system, the dielectric function generated may be used to calculate the energy of unfolding some or all of a protein. To apply the dielectric function in this manner, the following may be performed:
1. Generate 1 or more representative conformers of a natively folded protein, either from experimental high-resolution structural studies such as nuclear magnetic resonance or x-ray crystallography, or from molecular dynamics simulations.
2. Generate 1 or more representative conformers of the protein with part or all of it unfolded. This may be accomplished by restrained steered molecular dynamics simulation using one of the conformers in (1) as an initial structure, whereby atoms in parts of the protein that must not unfold are fixed in place, and a pulling force or large thermal energy is applied to atoms in parts of the protein that are desired to unfold.
3. Using the conformers generated in (1) as input for the foregoing exemplary method or system, generate a dielectric function around the natively folded protein.
4. Using the conformers generated in (2) as input for the foregoing exemplary method or system, generate a dielectric function around the unfolded or partially unfolded protein.
5. Calculate the electrostatic potential and associated electrostatic energies of the natively folded protein by solution of the Poisson-Boltzmann equation with the conformers from (1) and the calculated dielectric function from (3) as input.
6. Calculate the electrostatic potential and associated electrostatic energies of the unfolded or partially unfolded protein by solution of the Poisson-Boltzmann equation with the conformers from (2) and the calculated dielectric function from (4) as input.
7. Subtract the average of energies obtained in (5) from the average of energies obtained in (6) to determine the electrostatic energy difference between the folded and unfolded or partially unfolded protein.

Application to Equilibrium Acid/Base Dissociation Constants

In another application of the foregoing exemplary method and system, the dielectric function generated may be used to calculate the equilibrium dissociation constant (Ka or pKa=−log 10(Ka)) for ionizable groups in a protein, specifically the N-terminus, the C-terminus, and the side chains of aspartic acid/aspartate, glutamic acid/glutamate, histidine, lysine, arginine, cysteine, and tyrosine. This may be implemented by performing the following:
1. Obtaining or generating the structure of a protein with an ionizable group of interest in its protonated state, and using this structure as input for the foregoing exemplary method or system to calculate the dielectric function in and around this structure.
2. Obtaining or generating the structure of a protein with an ionizable group of interest in its unprotonated state, and using this structure as input for the foregoing exemplary method or system to calculate the dielectric function in and around this structure.
3. Calculating the electrostatic potential and associated electrostatic energies of the protonated structure by solution of the Poisson-Boltzmann equation with the structure and the calculated dielectric function from (1) as input.
4. Calculating the electrostatic potential and associated electrostatic energies of unprotonated structure by solution of the Poisson-Boltzmann equation with the structure and the calculated dielectric function from (1) as input.
5. Subtracting the energy obtained in (3) from the energy obtained in (4) to obtain the difference in energy Delta E (in kJ) between the protonated and unprotonated structures.
6. Converting the energy difference into a change in pKa (Delta pKa) by application of the following formula: Delta pKa=Delta E/(2.303*R*T), where R is the universal gas constant (in kJ/(mol*K)) and T is the absolute temperature (in K).
7. Adding the quantity to the experimentally known pKa of a model reference compound to obtain the pKa of the ionizable group of interest in the protein.

Application to Protein/Protein Interactions

In yet another application of the foregoing exemplary method and system, the dielectric function generated may be used to predict the energies of protein-protein interactions. The may be implemented by performing the following:
1. Obtaining or generating the structure of a first protein of interest, and using this structure as input for the foregoing exemplary method or system to calculate the dielectric function in and around this structure.
2. Obtaining or generating the structure of a second protein of interest, and using this structure as input for the foregoing exemplary method or system to calculate the dielectric function in and around this structure.
3. Using molecular modeling software to place the first and second structures in apposition or proximity, and using the system formed from the two structures as input for the foregoing exemplary method or system to calculate the dielectric function in and around this combined structure.
4. Calculating the electrostatic potential and associated electrostatic energies of the first protein structure by solution of the Poisson-Boltzmann equation with the structure and the calculated dielectric function from (1) as input.
5. Calculating the electrostatic potential and associated electrostatic energies of the second protein structure by solution of the Poisson-Boltzmann equation with the structure and the calculated dielectric function from (2) as input.
6. Calculating the electrostatic potential and associated electrostatic energies of the combined structure by solution of the Poisson-Boltzmann equation with the structure and the calculated dielectric function from (3) as input.
7. Subtracting the sum of the energy calculated in (4) and the energy calculated in (5) from the energy calculated in (6) to obtain the energy of interaction between the first and the second protein.

Application to Ligand Docking

In yet another application of the foregoing exemplary method and system, the dielectric function generated may be used to predict the energies of interaction between a protein and a non-protein molecule, such as a lipid, polysaccharide, nucleotide or other organic or inorganic molecule. This may be accomplished by performing:
1. Obtaining or generating the structure of a protein of interest, and using this structure as input for the foregoing exemplary method or system to calculate the dielectric function in and around this structure.
2. Obtaining the structure of a non-protein ligand molecule.
3. Using molecular modelling software to place the ligand molecule in proximity to the protein molecule structure from (1).
4. Calculating the electrostatic potential and associated electrostatic energies of the protein structure by solution of the Poisson-Boltzmann equation with the structure and the calculated dielectric function from (1) as input.
5. Calculating the electrostatic potential and associated electrostatic energies of the ligand structure by solution of the Poisson-Boltzmann equation with the structure from (2) placed according to the location determined for it in (3) and the calculated dielectric function from (1) as input.
6. Calculating the electrostatic potential and associated electrostatic energies of protein-ligand system by solution of the Poisson-Boltzmann equation with the structure from (3) and the calculated dielectric function from (1) as input.
7. Subtracting the sum of the energy calculated in (4) and the energy calculated in (5) from the energy calculated in (6) to obtain the energy of interaction between the protein and the ligand.

Application to Implicit Solvent Molecular Dynamics

In another application of the foregoing exemplary method and system, the exemplary method or system may be used to study the evolution in time of a molecular system by, for example, applying the exemplary method or system to determine the dielectric response in and around the system of interest, then providing this information as input to a program for molecular dynamics such as iAPBS/NAMD capable of using a Poisson-Boltzmann equation solver to determine the electrostatic and solvation forces in the system during the simulation.

For the sake of convenience, the exemplary embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

FIG. 2 is a flowchart of an exemplary method. Some of the blocks illustrated in the flowchart may be performed in an order other than that which is described. Also, it should be appreciated that not all of the blocks described in the flow chart are required to be performed, that additional blocks may be added, and that some of the illustrated blocks may be substituted with other blocks.

While particular example embodiments have been described in the foregoing, it is to be understood that other embodiments are possible and are intended to be included herein. It will be clear to any person skilled in the art that modifications of and adjustments to the foregoing example embodiments, not shown, are possible.

### REFERENCES

Aronoff-Speucer, E., Burns, c. s., Avdievich, N. I., Cerfen, G, J., Pelsaeh, J., Antholine, W. E. et al. 2000. Identification of the Cu2+ binding sites in the N-terminal domain of the prion protein by EPR and CD spectroscopy. Biochemistry 39(45): 13760-13771.
Baker, N. A., Sept, D., Joseph, S. Holst, M. J., and McCmmnon, J. A., 2001. Electrostatics of nanosystems: application to microtubules and the ribosome. Proc, Natl. Acad. Sci, USA 98(18): 10037-10041.
Bamdad, K, and Naderi-Manesh, H. 2007, Contribution of a putative salt bridge and backbone dynamics in the structural instability of human prion protein under r208h mutation, Biochem. Biophys, Res. Comm. 364(4) 719-724.
Bas, D. C., Rogers, D, M., and Jensen, J. H. 2008. Very fast prediction and rationalization of pKa values for protein-ligand complexes, Proteins 73(3): 765-783.
Brooks, B. R., Bruccoleri, R. E., Olafson, D. J., States, D. J., Swaminathan, S., and Karplus, M. 1983. CHARMM: A program for macromolecular energy, minimization, and dynamics calculations. J. Comp. Chem. 4(2): 187-217.
Caughey, B., Baron, G. S., Chesebro, B., and Jeffrey, M. 2009. Getting a Grip on Prions: Oligomers, Amylolds, and Pathological Membrane Interactions. Ann. Rev. Biochem. 78(1): 117-204.
Calzolai, L., Lysek, D, A., Perez, D. R., Guntert, P. and Wuthrich, K. 2005, Prions protein NMR structures of chickens, turtles, and frogs. Proc. Natl. Acad. Sci. USA. 102(3): 651-655.
Chiti, F. Stefani, M., Taddei, N., Ramponi, G., and Dobson, C. M. 2003. Rationalization of the effects of mutations on peptide and protein aggregation rates, Nature 424: 805-808.
Christen R., Hornemanrr, S., Damberger, F. F., and Wuthrich, K. 2009. Prion protein NMR structure from tammar wallaby (Macropus eugenii) shows that the beta2-alpha2 loop is modulated by long-range sequence effects. Mol. Biol. 389(5); 833-845.
Cobb, N. J., Sonnichsen, F. D., McHaourab, H., and Surewiez, W. K., 2007. Molecular architecture of human prion protein amyloid: a parallel, in-register beta-structure. Proc. Natl. Acad, Sci. USA, 104(48): 18946-18951.
DeMarco, M. I, and Daggett, V. 2007. Molecular mechanism for low pH triggered misfolding of the human prion protein. Biochemistry 46(11): 3045-3054.
Dima, R. I. and Thirumalai, D. 2004. Proteins associated with deceases show enhanced sequence correlation between charged residues. Bioinformatics 20(15): 2345-2354.
Frohlich, H., 194.9. Theory of Dielectrics, Clarendon Press, London, UK.
Gessert, A. D., Bonjour, S., Lysek, D. A., Fiorito, F., and Wuthrich. K.

2005. Prion protein NMR structures of elk and of mouse/elk hybrids. Proc, Natl. Acad.

Sci. U.S.A 102(3): 646-650.
Govaerts, C, Wille, H., Prusiner, S B., and Cohen, F. E. 2004 Evidence for assembly of prions with left-handed beta-helices into trimers. Proc, Natl. Acad. Sci. USA 101(22): 8342-8347.
Gu, W., Wang, T., Zhu, J. Shi, Y, and Lin, H. 2003. Molecular dynamics simulation of the unfolding of the human prion protein domain under low pH and high temperature conditions. Biophys. Chem. 104(1): 79-94.
Guest, W., Cashman, N. R., and Plotkin, S. S. 2009. On the inhomogeneous and anisotropic dielectric properties of proteins. Submitted J. Am. Chem. Soc.
Hornemann, S. and Glockshuber, R. 1998. A scrapie-like unfolding intermediate of the prion protein domain PrP(121-231) induced by acidic pH. Proc. Nail. Acad. Sci. USA 95(11): 6010-6014.
Kovacs, G. G., Trabattoni, G., Hainfellner, J. A., Ironside, J. W., Knight, R. S., and Budka, H. 2002. Mutations of the prion protein gene phenotypic spectrum, J. Neurol. 249(11): 1567-1582.
Kumar, S., and Nussinov. R. 1999. Salt bridge stability in monomeric proteins. J. Mol. Biol. 293(5): 1241.
Langella, K, Improta, R, and Barone, V. 2004. Checking the pH-induced conformational transition of prion protein by molecular dynamics simulations; effect of protonntion of histidine residues. Bicphys. J. 87(6); 3623-3632.
Li, L., Guest, W., Huang, A., Plotkin, S. S., and Cashman, N. R. 2009. Immunological mimicry of PrPC-PrPSc interactions: antibody-induced PrP misfolding. Protein Eng. Des, Sel. 22(8): 523-529.
Liemann, S. and Glockshuher, R. 1999. Influence of amino add substitutions related to inherited human priori diseases on the thermodynamic stability of the cellular prion protein. Biochemistry 38 (11): 3258-3267.
Liu, H. Farr-Jones, S., Ulyanov, N Llinas, M., Marqusee, K, Groth, D. et al, 1999. Solution structure of Syrian hamster prion protein rPrP(90-231). Biochemistry 38(17): 5362-5377.
Lopez Garcia, F., Zahn, R, Riek, R. and Wuthrich, K. 2000. NMR solution of the bovine prion protem, Prot. Natl. Acad, Sci. U.S.A. 97(1): 8334-0.8339.
Lysek, D. A., Sehorn. c., Nivon, L G., Esteve-Moya V., Christen, R, Calzolai, L. et al. 2005. Prion protein NMR structures of cats, dogs, pigs, and sheep. Proc. Natl. Aced. Sci. U.S.A. 102(3): 640-645.
Mills, N. L., Surewicz, K, Surewicz, W. K, and Sonnlchsen, F. D. 2009. NMR studies of a pathogenic mutant (D178N) of the human prion protein. To be published.
Oster, G. and Krikwood, J. G. 1943. The influence of hindered molecular rotation on the dielectric constants of water, alcohols, and other polar liquids. J. Chem. Phys 11(125): 175-178.
Parnmithiotis, E., Pinard, M., Lawton, T., LaBoissiere, S., Leathers, V. L., Zou. W. et al. 2003. A prion protein epitope selective for the pathologically misfolded ccnformation. Natl. Med. 9: 893-899.
Polymenidou, M., Trusheim, H., Scallmech, L, Moos, R, Julius, C., Miele, G. et al. 2008. Canine MDCK cell lines are refractory to infection with human and mouse prions. Vaccine 26(21): 2601-2614.
Prusiuer, S. B. 1998. Prions. Proc. Natl. Acad. Sci. USA 95(23): 13363-13383.
Riek, R, Horemann, S., Wider, G., Billeter, M., Glockshuber, R., and Wuthrich, K, 1996. NMR structure of the mouse prion protein domain PrP(121-321). Nature 382(2): 180.182.
Speare, J. O., Rush, T. S., Bloom, M. E., and Caughey, B. 2008. The role of helix 1 aspartates and salt bridges in the stability and conversion of the prion protein. J Biol Chem 218(14): 12522-12529.
Swletnieki, W., Petersen, R. B, Cambetti, P. and Surewicz, W. K. 1998. Familial mutations and the thormodynarnic stability of the recombinant prion protein. J. Biol. Chem. 41(44): 31048-31052.
Tsemekhman, K, Goldschmidt, L, Eisenberg, D. and Baker, D. 2007. Cooperative hydrogen bonding in amyloid formation. Protein. Sci. 16(4): 761-764.
Viles, J. H., Donne, D., Kroon, G., Prusiner, S. B., Cohen, F. E., Dyson, H. J et al. 2001. Local structural plasticity of the prion protein. Analysis of NMR relaxation dynarrncs. Biochemistry 40(9):2743-2753.
Viles, J. H., Klewpatinond, M., and Nadal, R. C., 2008. Copper and the structural biology of the prion protein. Biochem. Soc. Trans., 36(6): 1288-1292.
Voges, D. find Karshikoif, A. 2000. A model of a. local dielectric constant in proteins. J. Chem. Phys. 108(5): 2219-2227.
Warwicker, J. 1999. Modelling charge interactions in the prion protein: predictions fix pathogenesis. FEES Letters 450(1): 144-148.
Zalm, R, Liu, A., Luhrs, T., Riek, R., Schroetter, C., Lopez Garcia, P., et al. 2000. NMR solution structure of the human prion protein. Proc. Natl. Acad. Sci. USA. 97(1): 145150.
Zhang, Y., Swietnicki, W. Zagorski, M. G., Surewicz, W. K., and Sonniehsen, F. D. 2000. Solution structure of the E200K variant of human prion protein. Implications for the mechanism of pathogenesis in Familial priori diseases, J. Biol. Chem., 275(43); 33650-33654.
Zuegg, J. and Gready, J. E. 1999. Molecular dynamics simulations of human prion protein: importance of correct treatment of electrostatic interactions. Biochemistry 38(42): 13862-13876.

1. A method for determining a localized dielectric property of a molecule, the method comprising:
obtaining a molecular model of at least a portion of the molecule;
partitioning the molecular model into cavities; and
iteratively determining, for each of the cavities, permittivity within the cavity based on permittivity outside of the cavity and electronic and nuclear polarizability within the cavity.

2. The method of claim 1 wherein obtaining the molecular model comprises:
determining the structure of the portion of the molecule by performing a molecular dynamics simulation of the portion of the molecule; and
selecting the molecular model that represents the structure of the portion of the molecule.

3. The method of claim 2 wherein the molecule comprises a protein and wherein selecting the molecular model comprises selecting a predetermined atomic-resolution protein structure.

4. The method of claim 2 wherein the molecule comprises a protein and wherein selecting the molecular model comprises determining a protein structure wherein the position of each of the atoms in the protein structure minimizes average root-mean-square deviation of the atoms over one or more of the frames.

5. The method of claim 2 wherein the molecular dynamics simulation comprises frames recording the portion of the molecule, and further comprising prior to iteratively determining permittivity:
identifying dipoles from the frames;
determining the locations of the dipoles in the frames; and
determining the electronic polarizability inside each of the cavities for which permittivity is to be determined from the locations of the dipoles, a fraction of the cavity occupied by a solvent in which the molecule is immersed, and freedom of the dipoles to reorient in response to an external field.

6. The method of claim 5, further comprising prior to iteratively determining permittivity:
determining the orientations of the dipoles in the frames;
determining correlations of the deviations of the dipoles over the frames; and
determining the nuclear polarizability inside the cavity from the locations, orientations, and deviations of the dipoles.

7. The method of claim 5 wherein the molecule comprises a protein and wherein identifying the dipoles from the frames comprises identifying one or both of the residue backbone and residue side chain of the portion of the protein represented in the frames.

8. The method of claim 1 wherein iteratively determining permittivity comprises:
determining a permittivity model of the permittivity inside the cavity based on the permittivity outside of the cavity and the electronic and nuclear polarizability within the cavity; and
iteratively solving the permittivity model to determine the permittivity within any particular one of the cavities by repeating until convergence:
(i) determining the permittivity outside the cavity based on average permittivity within a selected volume outside the cavity; and
(ii) determining the permittivity inside the cavity by solving the permittivity model associated with the cavity.

9. The method of claim 8 wherein determining the average permittivity within a selected volume outside the cavity comprises averaging the permittivity over points contained in the selected volume.

10. The method of claim 1 wherein the molecule is selected from the group comprising a protein, an inorganic molecule, an organic molecule, a lipid, and a nucleic acid.

11. The method of claim 1 wherein partitioning the molecular model into cavities comprises:
selecting a lattice of points separated by a fixed distance; and
locating one of the cavities around each of the points.

12. The method of claim 11 wherein each of the cavities is a sphere centered on one of the points.

13. The method of claim 1 wherein iteratively determining permittivity comprises determining:
∉₂=∈₁(2 [symbol] +I)(I− [symbol] )⁻¹,
wherein:
$$𝕎 ≡ I + \frac{3 {ɛ}_{1}}{2 {ɛ}_{1} + 1} ( \frac{( 1 + γ ℱα ) ( γ ) + αγ}{{a}^{3}} - ( 1 + γ ℱα ) ( I + γ ℱα ) )$$
$$γ = 1 / ( 1 - α ℱ )$$
$$ℱ = 2 ( {ɛ}_{1} - 1 ) / ( ( 2 {ɛ}_{1} + 1 ) {a}^{3} )$$
$$α ( r \vert a ) = {\sum }_{A = 1}^{N} {f}_{A} ( r \vert a ) {α}^{A} + {n}_{w} ( r \vert a ) {α}^{w}$$
$${ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T}$$
∉₂ is the tensorial permittivity inside the cavity;
∈₁ is the scalar permittivity outside the cavity;
I is the identity matrix;
a is the radius of the cavity;
α is the electronic polarizability in the cavity;
N is the total number of dipoles in the molecule;
ƒ_{A} is the average fraction of a dipole A in the cavity;
α^{A} is the electronic polarizability of a dipole A;
n_{w} is the number of solvent molecules in the cavity;
α^{A} is the electronic polarizability the solvent in the cavity; [symbol]
is the tensorial nuclear polarizability in the cavity; [symbol]
μᵢ^{A}μⱼ^{B} [symbol] is the correlation of the dipoles in the cavity over all frames;
k_{B} is the Boltzmann constant;
T is the temperature in degrees Kelvin;
ƒ_{B} is the average fraction of a dipole B in the cavity;
g is the Kirkwood factor giving the average sum of the dot products of a solvent molecule's dipole moment with those of its nearest neighbors;
p is the permanent dipole moment of the solvent molecules; and
δᵢⱼ is the Kronecker delta function defined to be 1 if i=j and 0 otherwise.

14. The method of claim 13, further comprising reducing the tensorial permittivity inside the cavity to a scalar quantity by averaging eigenvalues of the tensorial permittivity.

15. The method of claim 14 wherein the eigenvalues are averaged by determining any one or more of geometric, harmonic, and arithmetic means.

16. The method of claim 1, further comprising using the permittivity determined in any one or more the cavities to model protein unfolding.

17. The method of claim 1, further comprising using the permittivity determined in any one or more the cavities to calculate equilibrium acid/base dissociation constants for ionizable groups in a protein.

18. The method of claim 1, further comprising using the permittivity determined in any one or more the cavities to predict protein-protein interactions.

19. The method of claim 1, further comprising using the permittivity determined in any one or more the cavities to calculate ligand docking energies for computer-aided drug design.

20. The method of claim 1, further comprising using the permittivity determined in any one or more the cavities to calculate interaction energies between charged groups within a protein, and their enthalpy of transfer into different solvent conditions.

21. The method of claim 1, further comprising using the permittivity determined in any one or more the cavities as an implicit solvation model in molecular dynamics.

22. A system for determining a localized dielectric property of a molecule, the system comprising:
an input unit configured to obtain a molecular model of at least a portion of the molecule;
a partitioning unit configured to partition the molecular model into cavities; and
a permittivity computation unit configured to iteratively determine, for each of the cavities, permittivity within the cavity based on permittivity outside of the cavity and electronic and nuclear polarizability within the cavity.

23. The system of claim 22 wherein the molecular model is obtained by a method comprising:
determining the structure of a portion of the molecule by performing a molecular dynamics simulation of the portion of the molecule; and
selecting the molecular model that represents the structure of the portion of the molecule.

24. A system of claim 23 wherein the molecule comprises a protein and wherein selecting the molecular model comprises selecting a predetermined atomic-resolution protein structure.

25. The system of claim 23 wherein the molecule comprises a protein and wherein selecting the molecular model comprises determining a protein structure wherein the position of each of the atoms in the protein structure minimizes average root-mean-square deviation of the atoms over one or more of the frames.

26. The system of claim 23 wherein the molecular dynamics simulation comprises frames recording the portion of the molecule, and further comprising a dipole identification unit configured to identify dipoles from the frames and to determine the locations of the dipoles in the frames, and wherein the permittivity computation unit is further configured to determine the electronic polarizability inside each of the cavities for which permittivity is to be determined from the locations of the dipoles, a fraction of the cavity occupied by a solvent in which the molecule is immersed, and freedom of the dipoles to reorient in response to an external field.

27. The system of claim 26 wherein the dipole identification unit is further configured to determine the orientations of the dipoles in the frames and the correlations of the deviations of the dipoles over the frames, and wherein the permittivity computation unit is further configured to determine the nuclear polarizability inside the cavity from the locations, orientation, and deviations of the dipoles.

28. The system of claim 26 wherein the molecule comprises a protein and wherein identifying the dipoles from the frames comprises identifying one or both of the residue backbone and residue side chain of the portion of the protein represented in the frames.

29. The system of claim 22 wherein the permittivity computation unit is further configured to:
determine a permittivity model of the permittivity inside the cavity based on the permittivity outside of the cavity and the electronic and nuclear polarizability within the cavity; and
iteratively solve the permittivity model to determine the permittivity within any particular one of the cavities by repeating until convergence:
(i) determining the permittivity outside the cavity based on average permittivity within a selected volume outside the cavity; and
(ii) determining the permittivity inside the cavity by solving the permittivity model associated with the cavity.

30. The system of claim 29 wherein the permittivity computation unit is configured to determine the average permittivity within a selected volume outside the cavity according to a method comprising averaging the permittivity over points contained in the selected volume.

31. The system of claim 22 wherein the molecule is selected from the group comprising a protein, an inorganic molecule, an organic molecule, a lipid, and a nucleic acid.

32. The system of claim 22 wherein the partitioning unit is configured to partition the molecular model into cavities according to a method comprising:
selecting a lattice of points separated by a fixed distance; and
locating one of the cavities around each of the points.

33. The system of claim 32 wherein each of the cavities is a sphere centered on one of the points.

34. The system of claim 22 wherein the permittivity computation unit is configured to determine permittivity within any particular one of the cavities by determining:
∉₂=∈₁(2 [symbol] +I)(I− [symbol] )⁻¹,
wherein:
$$𝕎 ≡ I + \frac{3 {ɛ}_{1}}{2 {ɛ}_{1} + 1} ( \frac{( 1 + γ ℱα ) ( γ ) + αγ}{{a}^{3}} - ( 1 + γ ℱα ) ( I + γ ℱα ) )$$
$$γ = 1 / ( 1 - α ℱ )$$
$$ℱ = 2 ( {ɛ}_{1} - 1 ) / ( ( 2 {ɛ}_{1} + 1 ) {a}^{3} )$$
$$α ( r \vert a ) = {\sum }_{A = 1}^{N} {f}_{A} ( r \vert a ) {α}^{A} + {n}_{w} ( r \vert a ) {α}^{w}$$
$${ij}_{} ( r \vert a ) = {f}_{A} \frac{{〈 {μ}_{i}^{A} {μ}_{j}^{B} 〉}_{0}}{{k}_{B} T} + 2 ℱ {f}_{A} {f}_{B} ( \frac{{n}_{w} {gp}^{2}}{3 {k}_{B} T} ) \frac{{〈 {μ}_{i}^{A} {μ}_{j}^{B} 〉}_{0}}{{k}_{B} T} + {δ}_{ij} \frac{{n}_{w} {gp}^{2}}{3 {k}_{B} T}$$
∉₂ is the tensorial permittivity inside the cavity;
∈₁ is the scalar permittivity outside the cavity;
I is the identity matrix;
a is the radius of the cavity;
α is the electronic polarizability in the cavity;
N is the total number of dipoles in the molecule;
ƒ_{A} is the average fraction of a dipole A in the cavity;
α^{A} is the electronic polarizability of a dipole A;
n_{w} is the number of solvent molecules in the cavity;
α^{A} is the electronic polarizability the solvent in the cavity; [symbol]
is the tensorial nuclear polarizability in the cavity; [symbol]
μᵢ^{A}μⱼ^{B} [symbol] is the correlation of the dipoles in the cavity over all frames;
k_{B} is the Boltzmann constant;
T is the temperature in degrees Kelvin;
ƒ_{B} is the average fraction of a dipole B in the cavity;
g is the Kirkwood factor giving the average sum of the dot products of a solvent molecule's dipole moment with those of its nearest neighbors;
p is the permanent dipole moment of the solvent molecules; and
δᵢⱼ is the Kronecker delta function defined to be 1 if i=j and 0 otherwise.

35. The system of claim 34 wherein the permittivity computation unit is further configured to reduce the tensorial permittivity inside the cavity to a scalar quantity by averaging eigenvalues of the tensorial permittivity.

36. The system of claim 35 wherein the eigenvalues are averaged by determining any one or more of geometric, harmonic, and arithmetic means.

37. The system of claim 22, further comprising an application unit configured to use the permittivity determined in any one or more the cavities to model protein unfolding.

38. The system of claim 22, further comprising an application unit configured to use the permittivity determined in any one or more the cavities to calculate equilibrium acid/base dissociation constants for ionizable groups in a protein.

39. The system of claim 22, further comprising an application unit configured to use the permittivity determined in any one or more the cavities to predict protein-protein interactions.

40. The system of claim 22, further comprising an application unit configured to use the permittivity determined in any one or more the cavities to calculate ligand docking energies for computer-aided drug design.

41. The system of claim 22, further comprising an application unit configured to use the permittivity determined in any one or more of the cavities to calculate interaction energies between charged groups within a protein, and their enthalpy of transfer into different solvent conditions.

42. The system of claim 22, further comprising an application unit configured to use the permittivity determined in any one or more the cavities as an implicit solvation model in molecular dynamics.

43. A computer readable medium having encoded thereon instructions that cause a computer processor to execute a method as claimed in claim 1.
